(19) United States
(12) Patent Application Publication
(10) Pub. No.: US 2013/0132216 A1
(43) Pub. Date: May 23, 2013

(54) POS INTERFACE (IF) EMULATOR

(71) Applicant: INTERNATIONAL BUSINESS MACHINES CORP, Armonk, NY (US)

(72) Inventors: Toru Aihara, Tokyo (JP); Noboru Kamijo, Tokyo (JP)

(73) Assignee: INTERNATIONAL BUSINESS MACHINES CORPORATION, Armonk, NY (US)

(21) Appl. No.: 13/655,559

(22) Filed: Oct. 19, 2012

(30) Foreign Application Priority Data
Nov. 18, 2011 (JP) 2011-252950

(51) Int. Cl. G06Q 20/20

(52) U.S. Cl. 705/16

(57) ABSTRACT

A point of sale interface (POS IF) emulator system includes a payment data processing-verification device that processes payment information in accordance with POS device information, emulates a POS input operation, and inputs the processed payment information to a POS device through a keyboard interface; the payment information being created from payment information extracted from shopping information and payment information acquired from user registration information, the shopping information being created by a mobile phone by acquiring item information from an item tag for an item and by performing the acquisition one or more times; wherein payment is made at the POS device corresponding to the POS device information.

### PRIORITY

This application claims priority to Japanese Patent Application No.: 2011-252950, filed Nov. 18, 2011, and all the benefits accruing therefrom under 35 U.S.C. §119, the contents of which in its entirety are herein incorporated by reference.

### BACKGROUND

The present invention relates to a method, a program product, and a system for a mobile shopping system in which a mobile device, such as a mobile phone or a smartphone, repeatedly performs the operation of scanning a barcode or IC chip of an item tag for an item to be purchased and acquiring item information to create shopping information, and sends the shopping information to a shopping-payment management system to complete payment.

The present invention also relates to a method, a program product, and a system for connecting a mobile shopping system to an existing POS system to process payment without changing the POS system in a store.

The present invention also relates to a method, a program product, and a system for providing a function that encourages a customer to actively scan item tags with a mobile phone or smartphone.

The present invention also relates to a method, a program product, and a system for providing a function that allows a customer to bookmark an item that the customer will possibly purchase in the future, and to purchase the bookmarked item under the same condition as when the item was bookmarked if they decide to purchase the item later.

The present invention also relates to a method, a program product, and a system for providing a large amount of additional information exceeding the limit of the two-dimensional barcode or IC chip, in order to encourage a customer to actively scan item tags by increasing the amount of information acquired by scanning an item tag with a mobile phone or smartphone and allow a store to effectively and efficiently provide sales promotion information beside the items.

The retail industry used to have roughly two types of stores: physical stores and EC (E-Commerce) sites. Due to the development process thereof, these two types are generally operated using completely different systems even within the same company. Physical stores traditionally use a POS (Point Of Sale) system for sales, stock, and order management. Payment for items is typically made by scanning barcodes of customer-selected items in a shopping cart one by one with a barcode reader at a checkout. Thus, the price often differs even among stores of the same chain. On the other hand, a chain generally has only one EC site which has rapidly developed with the widespread use of the Internet. Since the EC site has neither stores nor stock, the EC site sells the same item generally at a lower price than physical stores.

With the existing systems, it is difficult to implement a service that allows a customer to pay on an EC site for an item that the customer actually checked with their hands at a physical store in advance and decides to purchase, and allows a customer to receive at a physical store an item that was purchased on an EC site. At EC sites, all shopping activities are performed with a computer, and thus the shopping activities of a customer can be grasped easily. Specifically, which items a customer has checked and in what order the customer has or has not purchased items can be easily analyzed. Many EC sites carry out positive marketing and promotion based on shopping activity analysis.

However, physical stores, which account for most of the sales, obtain only information about items that were scanned during payment at a checkout and about the order in which the items were scanned, and have no means for grasping in what order the customer purchased the items. Thus, unlike EC sites, physical stores are unable to acquire a sufficient amount of data for analyzing the customer's shopping activities, and to perform effective marketing and promotion. Moreover, marketing and promotion of physical stores often offer unnecessary discounts that are inefficient for the stores or provide excessive information that makes customers get sick of, such as advertisement leaflets and uniform bargains, and consequently fail in sufficiently impressing the customers. It is important to narrow down promotion target customers and timely distribute promotion information.

The use of a multi-channel or omni-channel mechanism is also being considered. The mechanism integrates systems of physical stores and an EC site by using a recent mobile system exemplified by smartphones, thereby enabling delivery of an item desired by a customer and marketing and promotion.

As an example of the use of a mobile system, major European supermarket chains, such as Carrefour, Auchan, and Delhaize, and major American supermarket chains, such as Stop & Shop, have widely installed and developed a self-scanning solution, in which a WiFi wireless LAN is installed in a store, a dedicated wireless mobile device is lent to a customer, the customer scans barcodes of items with the mobile device, and the customer causes the mobile device to communicate with a POS system of the store to make payment.

In the United States, a Boston-based venture, AisleBuyer, has also developed a self-scanning solution using customers' smartphones. Also, a major British supermarket chain, Tesco (or Homeplus in South Korea) is trying out a virtual store, in which a poster including item images with barcodes is placed on a platform wall of a subway station or in an underground shopping mall in South Korea, a customer scans a barcode with a barcode reader of their smartphone to purchase an item on an EC site, then the purchased item is delivered to their home. There is also a similar pilot project in China.

In these smartphone-related solutions, each store creates a dedicated shopping application, which is downloaded to a customer's smartphone. During shopping, the customer scans the one-dimensional barcode attached to an item or the two-dimensional barcode (including the URL of the EC site and item barcode information) displayed at a shelf label. The smartphone then accesses the POS system of the store or the server of the EC site via the mobile phone network or WiFi wireless LAN, and searches for and acquires item information associated with the barcode in real time.

A major American supermarket chain, Kroger, is carrying out a trial of mobile shopping using smartphones in its stores. Kroger points out issues, such as low reading speed and reading rate of one-dimensional barcodes with cameras of smartphones (in general, one-dimensional barcodes do not have the error correction function, and thus are not suitable to be scanned with cameras), a difficulty in using a WiFi wireless LAN in the entire store without disconnection of communication, a complicated procedure of accessing a POS system of the store using smartphones, and a risk of disclosing item and price information to customers.

Also, when communication is performed using a mobile phone network, a service area and communication cost may also be problematic. As a method for addressing such issues a shopping support acquires content from an electronic shelf label (ESL). This shopping support uses an electronic shelf label system, which is increasingly installed in physical stores in order to avoid a difference between the displayed price and the paid price. Specifically, a two-dimensional barcode (QR code) for item information is displayed on an electronic shelf label that displays the price of the item by using the same item information database of a store system as that referred to by the POS. A customer scans this barcode with their mobile phone or smartphone, whereby the shopping support enables mobile shopping. The shopping support overcomes the issues pointed out by Kroger.

The shopping support enables shopping not only at a virtual store such as the example of Tesco and a showroom store only having samples but also at a physical store while allowing a customer to actually touch and check items. The shopping support also allows a physical store to grasp the shopping activities of a customer, which has not been acquired with a conventional POS system, and to perform new marketing and promotion based on data of the physical store and the EC site.

With this shopping support, it is possible to provide each customer with additional information and related promotion of an item that are personalized in accordance with their shopping context in a store, and to measure the degree at which the customer is interested in the provided information. Since contents of an electronic shelf label contain store information, a customer can shop at any store using one shopping application. However, since payment at physical stores is processed using a POS system, it is necessary to use a common system in physical stores and an EC site and to incorporate this shopping support into the POS system in order to realize this mechanism. Accordingly, for a retail business, the hurdle for installing this shopping support is not low.

### SUMMARY

In one embodiment, a point of sale interface (POS IF) emulator system, includes a payment data processing-verification device that processes payment information in accordance with POS device information, emulates a POS input operation, and inputs the processed payment information to a POS device through a keyboard interface; the payment information being created from payment information extracted from shopping information and payment information acquired from user registration information, the shopping information being created by a mobile phone by acquiring item information from an item tag for an item and by performing the acquisition one or more times; wherein payment is made at the POS device corresponding to the POS device information.

In another embodiment, a mobile shopping system includes a point of sale interface (POS IF) emulator system including a payment data processing-verification device that processes payment information in accordance with POS device information, emulates a POS input operation, and inputs the processed payment information to a POS device through a keyboard interface, the payment information being created from payment information extracted from shopping information and payment information acquired from user registration information, the shopping information being created by a mobile phone by acquiring item information from an item tag for an item and by performing the acquisition one or more times, wherein payment is made at the POS device corresponding to the POS device information; and a shopping-payment management system that extracts the payment information from the created shopping information and acquires the extracted payment information.

In another embodiment, a method of implementing a point of sale interface (POS IF) emulator system includes processing, with a payment data processing-verification device, payment information in accordance with POS device information, emulating a POS input operation, and inputting the processed payment information to a POS device through a keyboard interface; the payment information being created from payment information extracted from shopping information and payment information acquired from user registration information, the shopping information being created by a mobile phone by acquiring item information from an item tag for an item and by performing the acquisition one or more times; wherein payment is made at the POS device corresponding to the POS device information.

In another embodiment, a computer readable storage medium having computer readable instructions stored thereon that, when executed by a computer, perform a method of implementing a point of sale interface (POS IF) emulator system. The method includes processing, with a payment data processing-verification device, payment information in accordance with POS device information, emulating a POS input operation, and inputting the processed payment information to a POS device through a keyboard interface; the payment information being created from payment information extracted from shopping information and payment information acquired from user registration information, the shopping information being created by a mobile phone by acquiring item information from an item tag for an item and by performing the acquisition one or more times; wherein payment is made at the POS device corresponding to the POS device information.

### BRIEF DESCRIPTION OF THE SEVERAL VIEWS OF THE DRAWINGS

FIG. 1 is a configuration diagram illustrating devices, which the present invention applies to and/or work with a mobile shopping system.

FIG. 2 is a block diagram with all functions blocks that the present invention applies to and/or work with the mobile shopping system.

FIG. 3 is a diagram with hatched blocks that function in the mobile shopping system that uses a POS IF emulator.

FIG. 4 is a diagram with hatched blocks that function in the mobile shopping system that uses a prize processing system.

FIG. 5 is a diagram with hatched blocks that function in the mobile shopping system that uses a bookmark system.

FIG. 6 is a diagram with hatched blocks that function in the mobile shopping system that uses an item variation management system.

FIG. 7 is a diagram with hatched blocks that function in the mobile shopping system that uses a campaign information system.

FIG. 8 illustrates an example of item information acquired from item tags.

FIG. 9 illustrates an example of shopping information created by a mobile phone acquiring item information from item tags.

FIG. 10 illustrates an example of shopping information that is sent to a shopping-payment management system by a mobile phone at the time of payment.

FIG. 11 illustrates an example of shopping information created from a bookmark by a mobile phone.

FIG. 12 illustrates an example of shopping information sent to a shopping-payment management system by a mobile phone at the time of payment using a bookmark.

FIG. 13 illustrates an example of shopping information stored in a shopping information database.

FIG. 14 illustrates an example of payment information sent to a store system or a POS IF emulator by a shopping-payment management system.

FIG. 15 illustrates an example of shopping information when an order-combination-based prize is won.

FIG. 16 illustrates an example of order-combination-based prize data.

FIG. 17 illustrates an example of shopping information when a quantity-limited prize is won.

FIG. 18 illustrates an example of a quantity-limited prize data.

FIG. 19 illustrates an example of shopping information when a random prize is won.

FIG. 20 illustrates an example of random prize data.

FIG. 21 illustrates an example of keyboard input data.

FIG. 22 illustrates an example of information stored in an additional information database.

FIG. 23 illustrates an example of information stored in an item variation information management database.

FIG. 24 illustrates an example of information stored in a campaign information management database.

FIG. 25 is a flowchart illustrating an example of an operation of an item tag controller.

FIG. 26 is a flowchart illustrating an example of the operation of a mobile phone.

FIG. 27 is a flowchart illustrating an example of the operation of a shopping-payment management system.

FIG. 28 is a flowchart illustrating an example of the operation of a POS IF emulator.

FIG. 29 is a flowchart illustrating an example of the operation of a bookmark system.

FIG. 30 is a flowchart illustrating an example of the operation of a prize processing system.

FIG. 31 is a flowchart illustrating an example of the operation of the prize processing system for a prize win process.

FIG. 32 is flowchart illustrating an example of the operation for updating an additional information database of a mobile phone.

FIG. 33 is a flowchart illustrating an example of the operation for updating the additional information database of the mobile phone by a campaign management system.

FIG. 34 is a flowchart illustrating an example of the operation of an item variation management system.

FIG. 35 is a flowchart illustrating an example of the operation of a campaign information system.

FIG. 36 illustrates an overview of a mobile shopping assistant and an operation example thereof.

FIG. 37 illustrates an example of POS device information.

### DETAILED DESCRIPTION

In order to overcome mobile-shopping-system-related issues at retail stores, as pointed out by Kroger, it is an effective means for a mobile device, such as a mobile telephone or a smartphone, to repeatedly perform the operation of locally (without communication with an external server) scanning the two-dimensional barcode or IC chip of an item tag for an item to be purchased and acquiring item information to create shopping information, and to send the shopping information to a payment system using a mobile telephone network only at the time of payment, as proposed by IBM (which is a trademark of IBM Corporation).

The issues concerning low reading speed and reading rate of one-dimensional barcodes, issues concerning a WiFi wireless LAN, issues concerning a procedure of accessing a POS system of a store, and issues concerning disclosure of item and price information to customers can be addressed by locally scanning two-dimensional barcodes or IC chips.

Additionally, the use of the mobile phone network at the time of payment is to address the issues concerning a WiFi wireless LAN and the issues concerning a procedure of accessing a POS system of a store.

In a case of installing such a mobile shopping system in a retail store, there is a need to process payment using a POS system in the store because item information acquired from an item tag is supplied from a store system of the store. It is therefore desirable to connect a mobile shopping system to a conventional POS system in a retail store without changing the conventional POS system.

Additionally, it is necessary to encourage customers to actively scan item tags with their mobile phones or smartphones. Accordingly, a new function is needed that makes the customers feel the benefits of scanning The use of the mobile shopping system is desirably promoted by allowing a customer to automatically win a prize of a manufacturer or retail store if they use this system.

Moreover, since this system is used in physical stores, a customer cannot purchase an item at any desired time, unlike EC sites. Accordingly, a customer is desirably allowed to bookmark an item which they will possibly purchase in the future, and to purchase the bookmarked item under the same condition as when the item was bookmarked if they decide to purchase the item later.

For example, during an overseas trip or the like, a customer often forgets the location of a store that sells an interesting item in a big shopping mall including many stores, or often cannot return to the store due to their schedule. Even in such a case, the customer can purchase the item by bookmarking the item in advance.

Furthermore, it is necessary to provide a larger amount of additional information in some way since a customer wishes to acquire detailed information and personalized information of an item to carefully examine the item before purchasing it but the amount of information contained in the two-dimensional barcode or IC chip is limited. For example, increases in customer satisfaction and sales are desirably achieved by providing a customer who is interested in an item with information about other recommended related items (cross-selling and/or up-selling), variation information (items of different colors and/or sizes), and promotion-campaign information such as volume discount and/or combination discount, after narrowing down and personalizing these pieces of information taking into account the characteristics of the item of interest and the characteristics of the customer. In a simple practice, preparing as many item tags as the number of color and size variations of the item is desirably avoided (twelve item tags are needed for a clothing item of three colors and four sizes but the number of item tags is decreased to two).

Before shopping at a retail store using this mobile shopping system, a customer downloads a shopping application to their mobile device, such as a mobile phone or smartphone, in advance. This application can be downloaded from a download site specified by scanning a two-dimensional barcode or IC tag at the store. At this time, various pieces of information (such as user information, a payment account, and a delivery address) are registered. An item tag to be scanned with this shopping application contains store information. Thus, depending on the configuration of the system, the customer can use the shopping application at other retail stores if they download the shopping application once.

In order to perform shopping, a mobile device locally scans a barcode or IC chip of an item tag for an item to be purchased to acquire item information that contains the price. Since this item information is generated by a store system of this store, payment needs to be processed using the store system (including a POS system) of this store. The mobile device repeatedly acquires item information to perform a shopping process, creates shopping information containing information about customer's operations on the shopping application (i.e., the customer's shopping or purchase activities), and sends the shopping information to a shopping-payment management system via a 3G or GSM mobile phone network and the Internet. The shopping-payment management system stores this shopping information, creates payment information necessary for payment in the store, and sends the payment information to the store system, thereby completing payment. The shopping-payment management system then returns a payment result to the mobile device. If a retail store is hesitant about changing its store system in order to accept this payment (the change generally involves system integration and thus modification cost), the shopping-payment management system may complete payment by emulating an input directly using hardware interfaces, such as a keyboard and a display, of the POS system in the store.

In order to encourage a customer to actively use this system, the shopping-payment management system may apply pre-registered prize data of a manufacturer or retail store to payment information on condition that a specific item is contained in shopping information before completing payment, and may notify the mobile device of the result. If a customer once misses a chance to purchase an item at a physical store, the customer needs to re-visit the store to purchase the item. However, in this system, the mobile device creates, as a bookmark, shopping information of an item that may be purchased in the future. Accordingly, the customer can make payment later under the condition that was offered when the shopping information was created, by loading this bookmark without visiting the store. Since an item tag is associated with an item, the item tag needs to be attached to each item if the item has color and/or size variation information. However, in this system, the mobile device acquires additional information, such as color and/or size variation information of an item, from an additional information tag when creating shopping information, and reflects the additional information in the shopping information, whereby the number of item tags may be reduced.

Also, in this system, a code for related item information (such as promotion and campaign) is contained in an item tag as additional information. This allows the mobile device to acquire the related item information when acquiring item information, and to present the information to a customer. By including a common campaign code in an item tag for a certain group of items, the group of items may be set as targets of the common campaign (a clearance sale of winter clothing). Also, the meaning of the campaign code may be personalized for each customer, such that a 20% discount, 30% discount, or 40% discount. Furthermore, various campaigns and promotions, such as proposal/cross-selling of related items, may be provided.

The Following advantageous effects may be expected by using the present invention.

A retail store can overcome the technical issues related to a mobile shopping system using customers' mobile devices, as pointed out by Kroger, and easily install the mobile shopping system in the store. A retail store can also improve customer satisfaction by providing a customer with a new shopping experience using their mobile device, and perform new promotion and marketing based on the customer's shopping activities and trend.

An electronic shelf label supplier can add a mobile shopping function to electronic shelf labels used to be in place of paper shelf labels, propose a business that produces profits (such as purchase analysis, and campaign/promotion) in addition to proposing cost reduction (such as preventing troubles due to exchanging paper shelf labels in response to price changes and mismatch between the price shown on the paper shelf label and the POS price), and thus more positively develop their business.

An electronic shelf label supplier or service provider using electronic shelf labels can operate a shopping-payment management system in return for providing retail stores with electronic shelf labels and a shopping application for free, collect shopping information from all stores in the retail industry, and provide the shopping information to item manufacturers and marketing companies to earn profits, or itself perform promotion and marketing.

The shopping-payment management system may also be constructed as a cloud system.

An electronic shelf label supplier or service provider using electronic shelf labels can propose a method for enabling payment for mobile shopping without affecting the current store system of a retail store (including a POS system), and can give incentive to a retail store which is hesitant about installing a mobile shopping system due to the need for system integration.

An electronic shelf label supplier or service provider using electronic shelf labels can incorporate the above method in an electronic shelf label controller, thereby adding a mobile shopping function to an electronic shelf label system substantially without incurring extra cost. Mobile shopping is still allowed with paper shelf labels by including a printing process. Since a customer can obtain the right to win a prize by just shopping using their mobile device, they come to actively use this system.

Additionally, a manufacturer or retailer can promote sales of one or more items by offering a prize, and acquire shopping activity information and use the acquired information in the development and price setting of new products.

By providing an affiliate model (described later) as one type of prize, a retail store can more easily provide a similar service to a customer who is using software that allows the customer to purchase an item at a lower price on the EC site by scanning a barcode of the item at the store. This permits the store not only to earn profits from selling items directly, but also to earn profits from a charge of introducing the customer to another store (and of selling the item by the other store).

In addition to ordinary shopping, a customer can bookmark an interesting item and purchase the item at any desired time under the condition offered at the time of bookmarking, using their mobile device.

Additionally, a retail store can get new business opportunities related to hitherto lost customers, such as those who regret that they have forgotten to or failed to buy an item. Particularly, a retail store can provide customers who visit the retail store during overseas trips with new services (such as services for travel agencies that provide a service for preparing souvenirs by delivering items to an airport from which tourists will leave or a hotel at which the tourists are staying if the tourists bookmark items that they are undecided as to whether to purchase at sightseeing spots and then decide to purchase the items before they return to their countries).

Additional information and related promotion of an item can be provided to a customer in a retail store after being personalized for the customer in accordance with their shopping context. Furthermore, the degree at which the customer is interested in the provided information can be measured. The provided information is not only timely and beneficial information for the customer but also permits the retail store to perform effective one-to-one marketing on the customer.

Information on other recommended related items (cross-selling and/or up-selling), variation information (items of different colors and/or sizes), and information such as volume discount and/or combination discount can be provided to a customer who is interested in an item after these pieces of information are narrowed down and personalized taking into account characteristics of the item of interest and characteristics of the customer, increasing customer satisfaction and sales. In this way, effective advertising can be performed by optimizing target customers and/or timings of distribution, unlike ineffective and uniform advertisement mails that are sent periodically, make customers get sick of, and remain unread. Additionally, a more effective campaign can be performed by narrowing down distribution targets and personalizing content of discount, unlike advertisements today, such as uniform discount advertisement leaflets distributed on the street or with newspapers, which are not to be read by many customers but offer discount even to people on whom little effect of the campaign is expected.

A retail store can stop providing unnecessary and inefficient discount and excessive information that makes customers get sick of, such as advertisement leaflets and uniform bargains, and can filter and timely distribute information. Additionally, a retail store can use this system as a tool of performing cross-selling and/or up-selling.

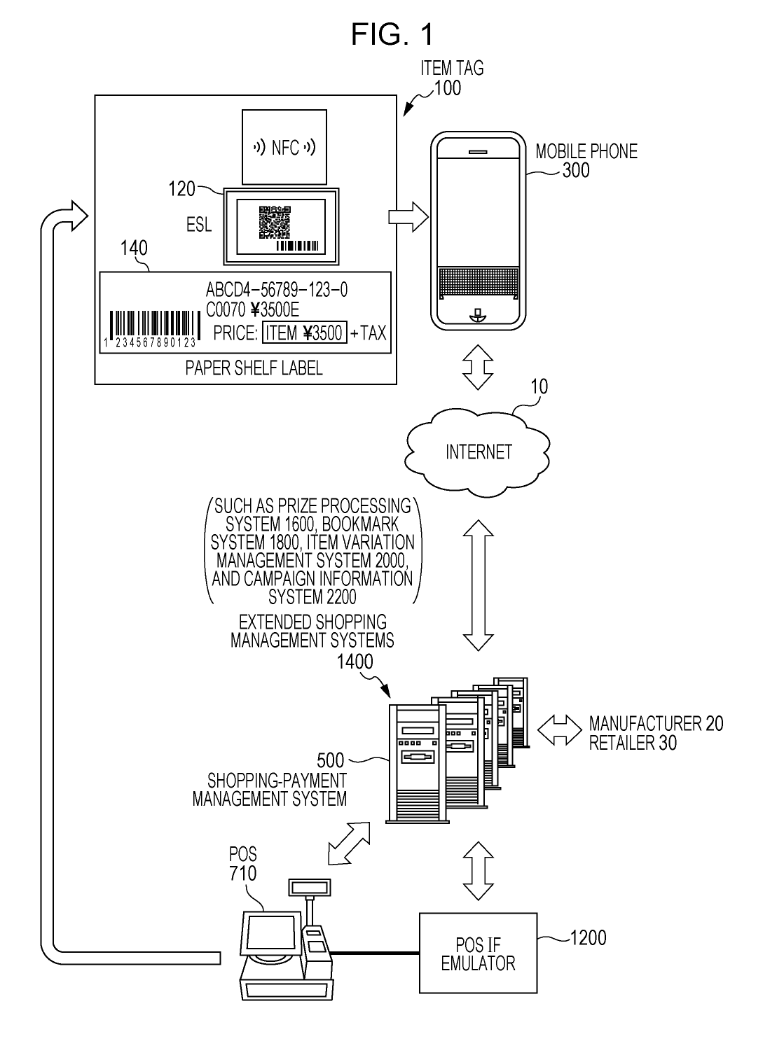

FIG. 1 is a configuration diagram illustrating devices that constitute the entire mobile shopping system (a plurality of data processing systems) which the present invention applies to and works with. The mobile shopping system includes, as its basic components, item tags 100, such as ESLs (Electronic Shelf Labels) 120 and paper shelf labels 140, a mobile device 300, such as a mobile phone or a smartphone, the Internet 10, a shopping-payment management system 500, a store system 700 including a POS 710. Depending on additional functions, the mobile shopping system further includes a POS IF emulator 1200 and extended shopping management systems 1400 (e.g., a prize processing system 1600, a bookmark system 1800, an item variation management system 2000, and a campaign information system 2200).

A description will be given in following embodiments assuming that the mobile device 300 is, but not limited to, a mobile phone that is a representative form of the mobile device 300. The mobile device 300 may be a dedicated shopping device 300, such as one used for self-scanning shopping in Europe.

A description will be given in the following embodiments assuming that the item tags 100 are, but not limited to, the ESLs 120 and the paper shelf labels 140 that are representative forms of the item tags 100. Herein, the item tags 100 indicate labels directly adhered on items, small paper tags (item labels or price labels) attached to items using thread or the like, or shelf labels or digital signage that are placed at item shelves or show windows for items. Furthermore, the item tag 100 indicates item information (such as a two-dimensional barcode presented with the item name and the price, or an IC chip embedded in paper) that is associated with or related to an item in a mail-order catalog or a menu at a restaurant.

In addition to basic item information, such as the item name and the price typically shown on a label or shelf label, the item tag 100 contains more information as coded information. Accordingly, the mobile device 300 can easily acquire the coded information provided by the item tag 100 by a customer scanning the item tag 100 with it (or placing it over the item tag 100). The mobile device 100 acquires as digital information the coded item information from the item tag 100 by reading the two-dimensional barcode and performing NFC communication and Bluetooth communication.

A description will be given in the following embodiments assuming that the item tag 100 is, in most cases, but not limited to, the ESL 120 capable of displaying a two-dimensional barcode, which is a representative form of the item tag 100. A shopping application is provided for the mobile device 300. Most functions can be implemented by just installing such software and making use of existing hardware. Thus, the mobile terminal 300 may be a means for implementing the functions.

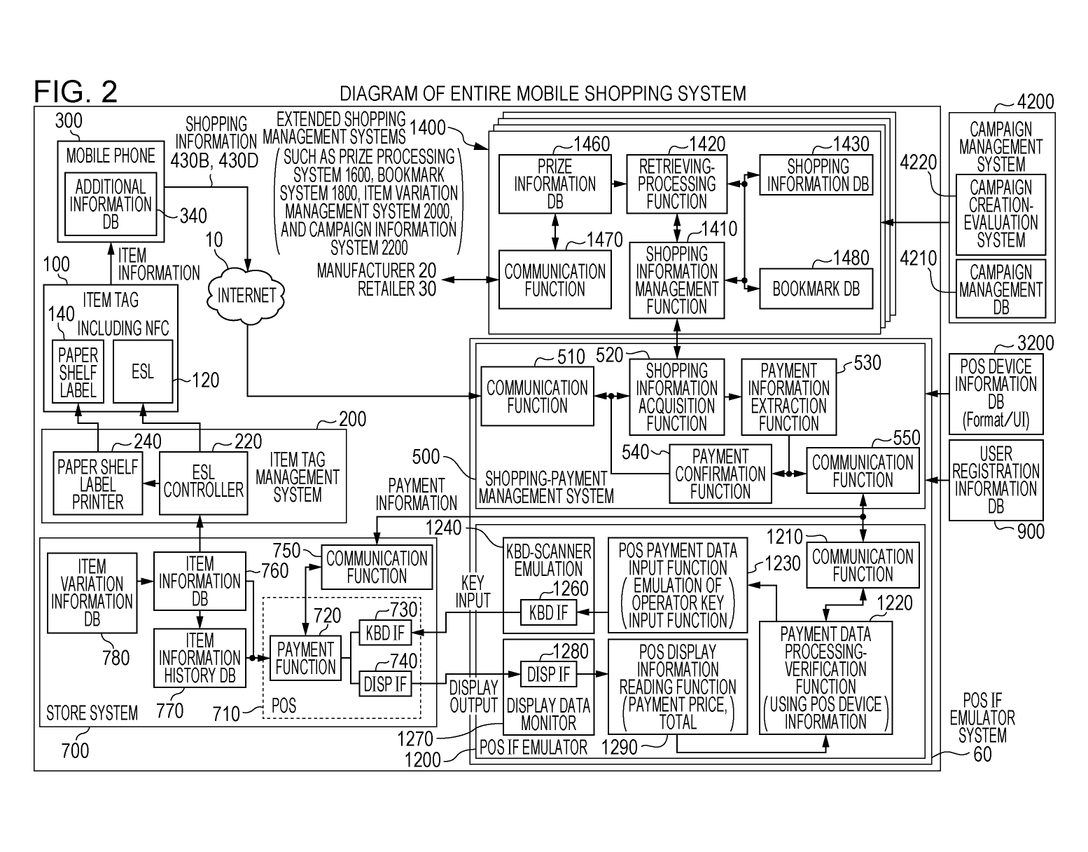

FIG. 2 illustrates these functions as a block diagram. The item tag 100 acquires item information 760 from the store system 700, stores the acquired item information 760 therein, and provides the item information 760 by displaying, printing, etc. The mobile phone 300 acquires the item information 760 from the item tag 100 using the two-dimensional barcode (QR code or DataMetrics), the NFC (Near Field Communication) technology, and the Bluetooth technology. The mobile phone 300 adds shopping activity information, such as a purchase date and time 438, a quantity 440, an amount (subtotal) 441, a bookmark date and time 442 (described later), and (content) valid conditions 443, to the acquired item information 760, thereby creating shopping information 430A. This shopping information 430A may further include operation information of the mobile phone 300 necessary for analyzing shopping activities of the customer.

The mobile phone 300 repeatedly performs this operation to perform a shopping process. At the time of payment, the mobile phone 300 adds a payment date and time 439 to the shopping information 430A to create shopping information 430B, and transfers the shopping information 430B to the shopping-payment management system 500. Specifically, the mobile phone 300 accesses the Internet 10 using a 3G or GSM mobile phone network, and sends the shopping information 430B to the shopping-payment management system 500.

These mobile phone networks are rapidly growing even in emerging countries, and have wider service areas and higher security levels against eavesdropping and tampering than the WiFi wireless LAN. When communication is performed over the Internet outside the mobile phone networks, encryption technologies are desirably used on the information. A shopping information acquisition function 520 of the shopping-payment management system 500 acquires the shopping information 430B from the mobile phone 300 via a communication function 510. A payment information extraction function 530 acquires payment registration information 586 corresponding to a user ID 431 contained in the shopping information 430B, from a user registration information database 900. The payment information extraction function 530 combines the payment registration information 586 with payment information components (581 to 585) extracted from the shopping information 430B, thereby creating payment information 580. A communication function 550 sends the payment information 580 to the store system 700 directly or via the POS IF (interface) emulator 1200 and the POS 710, thereby performing a payment process.

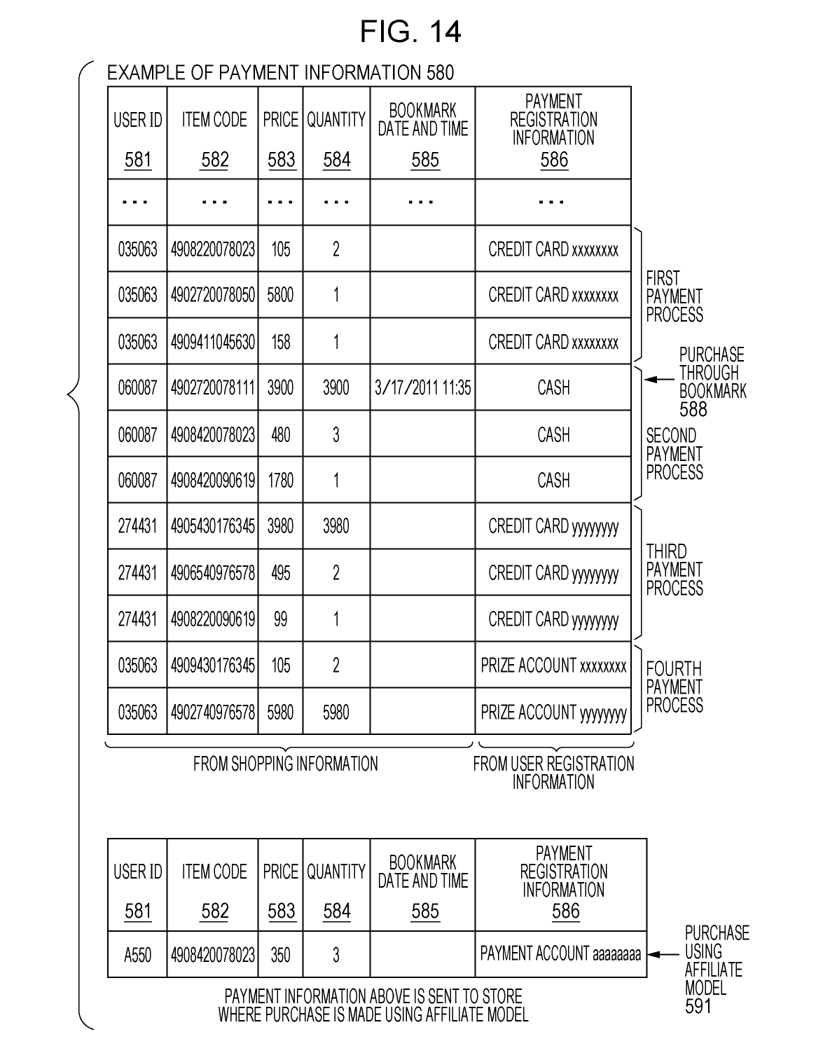

In an example of the payment information 580 of FIG. 14, pieces of information containing the same user ID 581 indicate the same payment process. In this example case, each of the first three pieces of information containing the user ID 581 “035063”, the next three pieces of information containing “060087”, the next three pieces of information containing “274431”, and the last two pieces of information containing “035063” is the same payment process. Thus, four payment processes are successively sent to the shopping-payment management system 500.

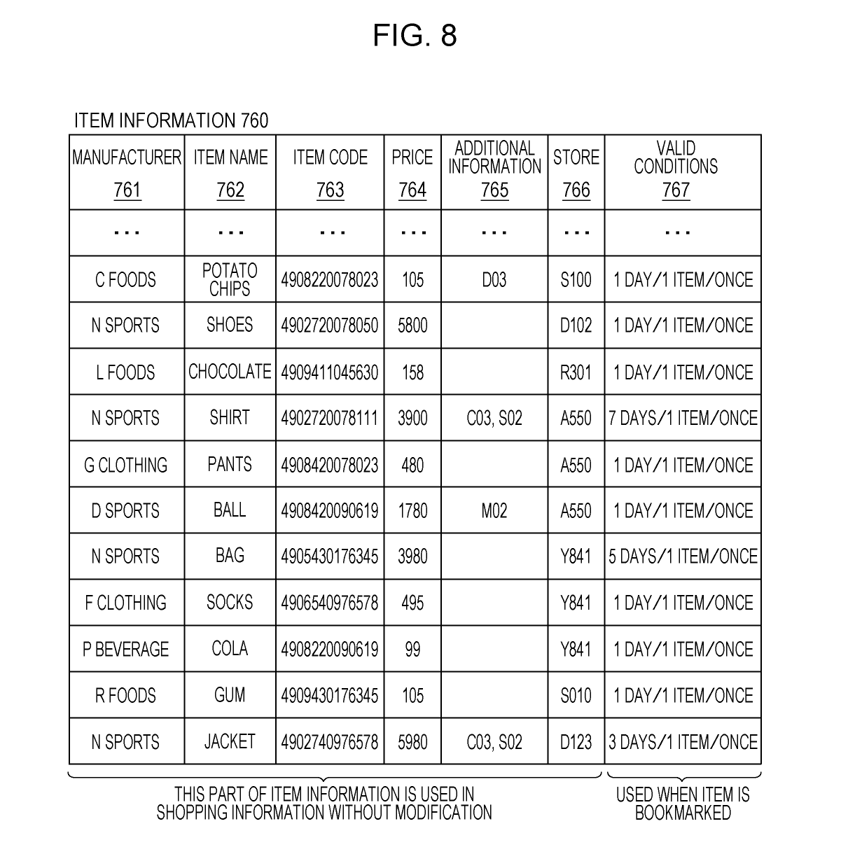

A payment result is confirmed by a payment confirmation function 540 via the communication function 550 of the shopping-payment management system 500, and then sent to the mobile phone 300 that sent a payment request. The mobile phone 300 displays the payment result on a screen, and terminates the shopping process. In an item tag management system 200, an ESL controller 220 acquires item information from an item information database 760 of the store system 700, and creates the item tag 100 for each item sold at the store. As illustrated in FIG. 8, the item information acquired from the item information database 760 contains a manufacturer name 761, an item name 762, an item code 763, a price 764, additional information 765, a store code 766, and valid conditions 767.

When the item tag 100 for an item is the ESL 120, the ESL controller 220 appropriately changes information displayed on the ESL 120 through wireless communication based on IR, radio, etc. When the item tag 100 for an item is the paper shelf label 140, the ESL controller 220 sends item information of the item to a paper shelf label printer 240. The paper shelf label printer 240 prints the item information as the paper shelf label 140. When printing the paper shelf label 140, the paper shelf label printer 240 prints, as coded information such as the two-dimensional barcode, more detailed item information (761 to 767) acquired from the item information database 760 in addition to the typically shown item name 762 and price 764.

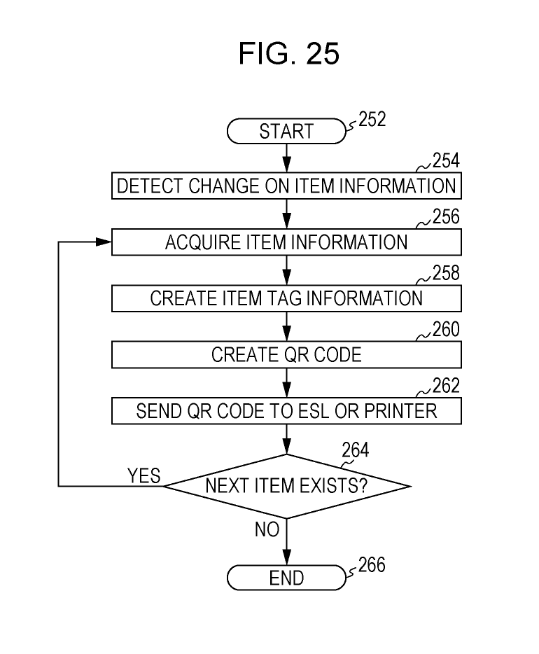

FIG. 25 is a flowchart illustrating an example of the operation of the item tag management system 200. Upon detecting a change in the item information database 760 of the store system 700 in block 254, the item tag management system 200 acquires the changed item information 760 in block 256, creates item tag information in block 258, creates a QR code from the item tag information in block 260, and sends the QR code to the ESL 120 or the paper shelf label printer 240 in block 262. The same process is repeated if item information of another item is changed.

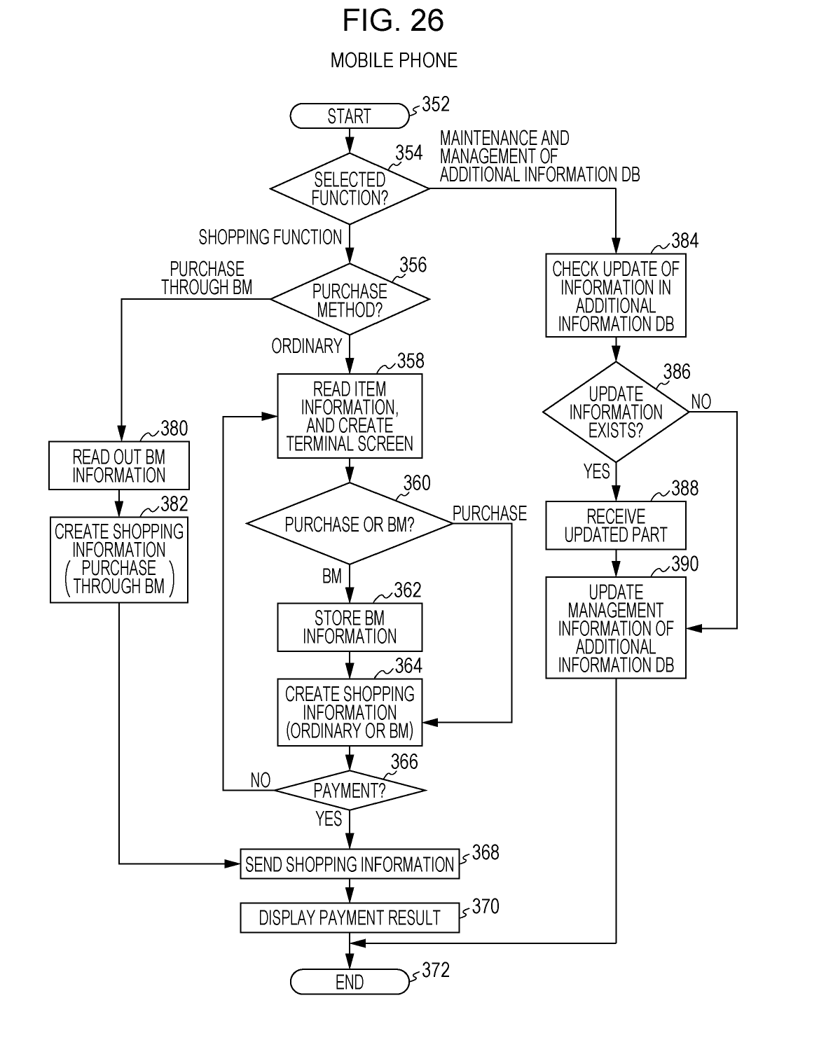

FIG. 26 is a flowchart illustrating an example of the operation of the mobile phone 300. The shopping application of the mobile phone 300 supports various functions. Thus, in block 354, there is a selection of functions. If the shopping function is selected, one of ordinary shopping or shopping of a bookmarked item is selected in block 356.

If ordinary shopping is selected in block 356, the mobile phone 300 displays a shopping screen, and scans the item tag 100 to acquire the item information 760 in block 358. In block 360, the mobile phone 300 determines which of ordinary purchase or bookmarking that allows the customer to later consider whether to purchase the item has been selected. In the case of ordinary purchase in block 360, the mobile phone 300 creates the shopping information 430A in block 364. Herein, “to create shopping information” includes “to update the existing shopping information by adding new information to the existing shopping information”. In the case of bookmarking in block 360, the mobile phone 300 stores information (shopping information related to a bookmark) of a line 449 of the shopping information 430A therein in block 362, and creates the shopping information 430A in block 364. Subsequently, if payment is selected in block 366, the mobile phone 300 adds the payment date and time 439 to the shopping information 430A to create the shopping information 430B, and sends the shopping information 430B to the shopping-payment management system 500 in block 368. In block 370, the mobile phone 300 acquires the payment result from the shopping-payment management system 500, and displays the payment result.

If purchase through a bookmark is selected in block 356, the mobile phone 300 reads the line 449 of the shopping information 430A stored in block 362 during the previous shopping process, in block 380. In block 382, the mobile phone 300 fills the purchase date and time 438, the quantity 440, and the subtotal 441, thereby creating shopping information 430C. In block 368, the mobile phone 300 adds the payment date and time 439 to the shopping information 430C, thereby creating shopping information 430D. Then, the mobile terminal 300 performs the same processing as that for the ordinary purchase.

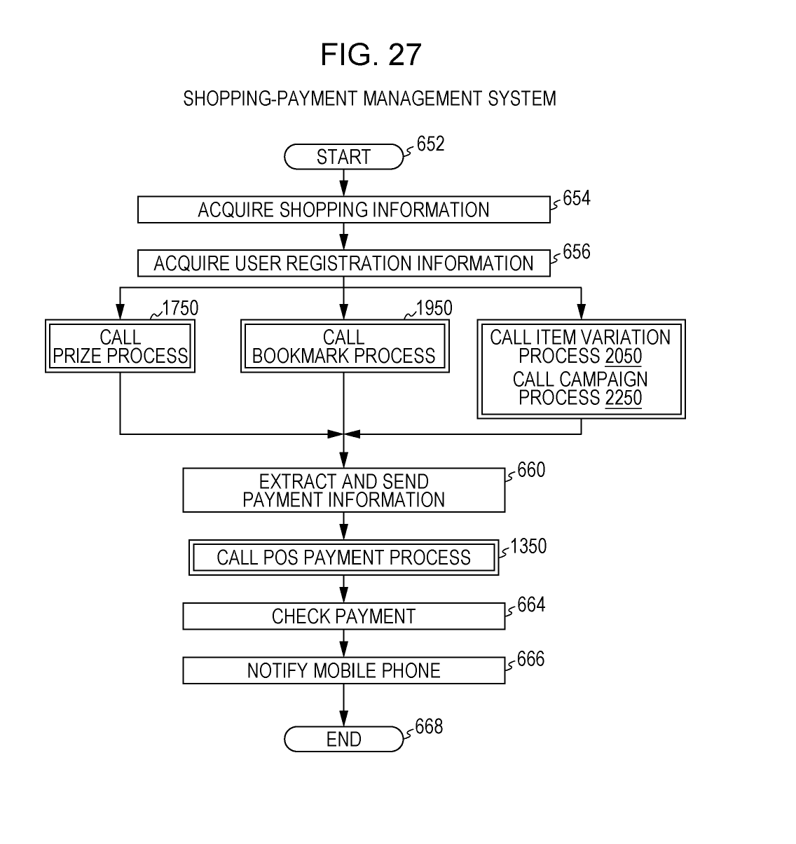

FIG. 27 is a flowchart illustrating an example of the operation of the shopping-payment management system 500. Upon receipt of a payment request from the mobile phone 300, the shopping-payment management system 500 acquires the shopping information 430B or 430D in block 654, and acquires registration information of a customer (user) who owns this mobile phone 300 from the user registration information database 900 by using the user ID 431 extracted from the shopping information 430B or 430D in block 656. This registration information contains the payment registration information 586 (such as the credit card number, cash payment, and the payment account number) to be included in the payment information 580. The payment registration information 586 is registered to the user registration information database 900 by this customer (user) with a store PC or a mobile phone when the customer starts using the mobile shopping system, along with permission for using their personal information, such as shopping activities and trends, acquired by this system.

If the mobile shopping system has additional functions (described later) related to the prize, the bookmark, the item variations, and the campaign, the corresponding systems perform processes in subsequent blocks 1750, 1950, 2050, and 2250, respectively. In block 660, the shopping-payment management system 500 extracts the user ID 431, the item code 434, the price 435, and the quantity 440 necessary for payment from the shopping information 430B or 430D, adds the payment registration information 586 acquired in block 656 to the extracted information to create the payment information 580, and sends the payment information 580 to the store system 700. When the payment information 580 is sent via the POS IF emulator 1200, a POS payment process (described later) is performed in block 1350 before the payment information 580 is sent to the store system 700. In block 664, payment is checked. In block 666, the shopping-payment management system 500 sends a notification to the mobile phone 300, and then terminates the payment process.

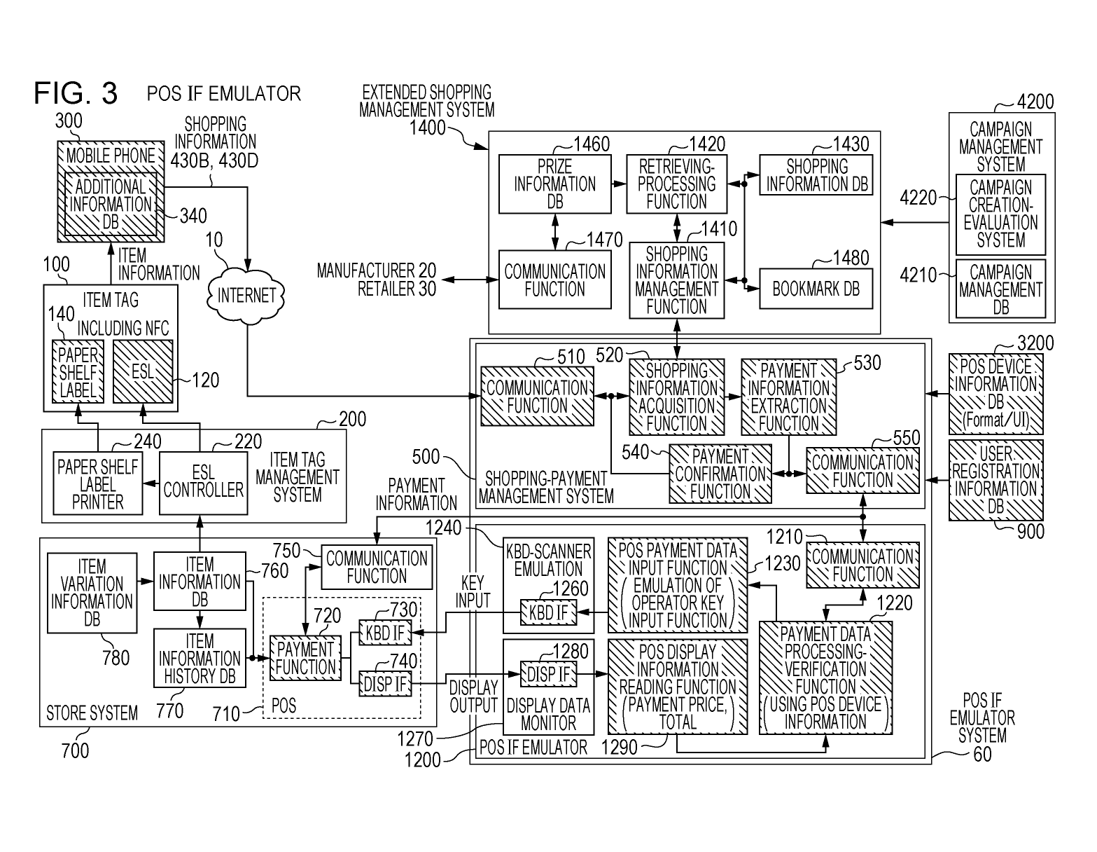

FIG. 3 is a diagram with hatched blocks that function in the mobile shopping system that uses the POS IF emulator 1200. When payment is processed via the POS IF emulator 1200, a payment data processing-verification function 1220 processes the payment information 580 received via a communication function 1210, in accordance with keyboard-scanner interface information, the operation procedure of a POS application, and so forth that are stored in a POS device information database 3200, thereby creating keyboard input data 1310. A POS payment data input function 1230 emulates POS input operations, thereby inputting the created keyboard input data 1310 to the POS 710 through a keyboard interface 1260.

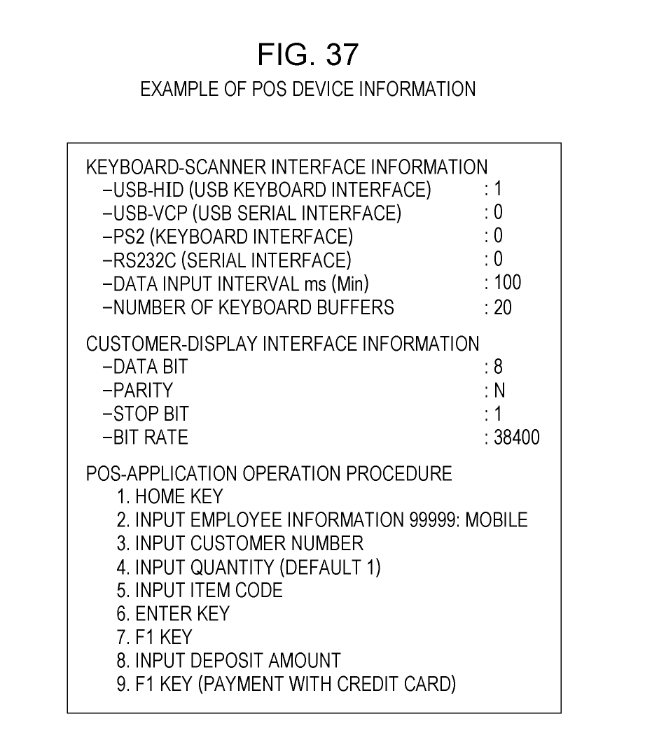

FIG. 37 illustrates an example of information stored in the POS device information database 3200. This POS device information database 3200 stores, for various POS devices, information necessary for inputting, such as types of keyboard interfaces (typically, a scanner is connected to a keyboard interface), the minimum data input interval, and the number of keyboard buffers (up to how many characters can be successively sent); communication parameters for information output from a customer display interface (typically, RS232 or the like is used); and information about the POS-application operation procedure. The POS IF emulator 1200 reads and utilizes information related to the communication destination POS.

The keyboard input data 1310 is input to the POS 710 through a KBD IF (keyboard interface) 730, as in the case of ordinary payment for items at a checkout. Every time data is input, the payment data processing-verification function 1220 of the POS IF emulator 1200 acquires an output from a DISP IF (display interface) 740 of a customer display (a small display directed toward a customer for checking the item name and price of the item being paid) of the POS 710, in accordance with the customer-display interface information stored in the POS device information database 3200.

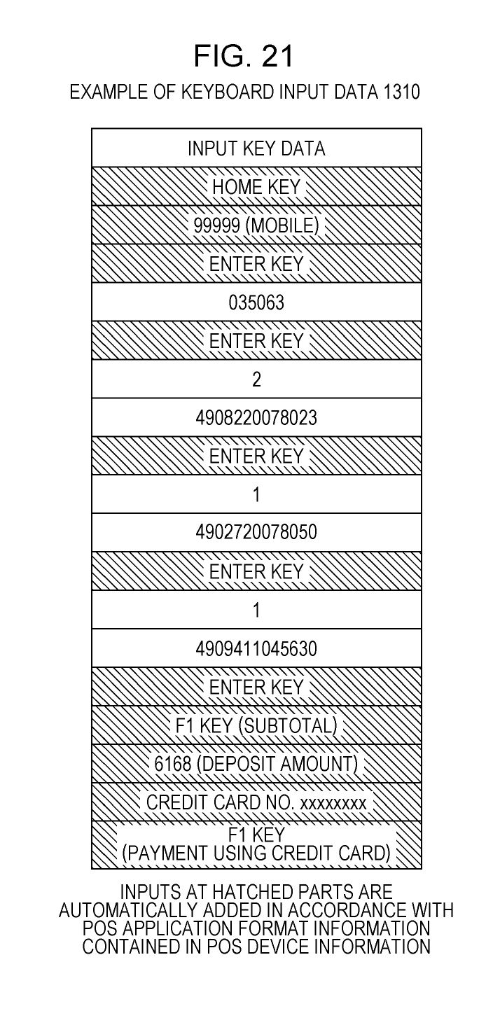

FIG. 21 illustrates an example of the keyboard input data 1310 created by the payment data processing-verification function 1220 from the payment information 580 in accordance with the POS-application operation procedure stored in the POS device information database 3200. The POS that is to receive the keyboard input data 1310 is typically operated in the following manner. First, the HOME key is pressed. A scanner scans the barcode (corresponding to 99999) of the POS operator's ID card. Since the scanner automatically adds the ENTER key after sending the data, the ENTER key is input next. The scanner then scans the barcode (corresponding to 035063) of the customer card, and inputs the ENTER key. Thereafter, barcodes of items are scanned.

The quantity of the first item is 2. Thus, the key “2” (which overwrites the key “1” that is initially assumed) is pressed, the barcode (corresponding to 4908220078023) of the item is scanned, and then the ENTER key is input. Since the quantity of the next item is 1 (the default is maintained), the barcode (corresponding to 4902720078050) of the item is scanned and the ENTER key is input. Since the quantity of the next item is also 1 (the default is maintained), the barcode (corresponding to 4909411045630) of the item is scanned and the ENTER key is input.

In order determine the subtotal, the F1 key is pressed. Then, the deposit amount “6168” is input. In order to pay with the credit card, the credit card number xxxxxxxx registered on the customer card is selected, and then the F1 key is pressed. In this way, payment is finished. In accordance with this procedure, the keyboard input data 1310 is created. The payment data processing-verification function 1220 of the POS IF emulator 1200 compares outputs displayed by the POS 710 and acquired via a display data monitor 1270 with the price 583 and the quantity 584 of the payment information 580 having been input to the POS 710. If these values do not match, the POS payment data input function 1230 emulates the POS operation, and inputs the canceling operation (specifically, a cancel key) to the POS 710 through the keyboard interface 1260.

Even if these values do not match, the canceling operation may be input to the POS 710 only when the price 583 of the payment information 580 having been input to the POS 710 is lower than the output. Alternatively, if these values do not match, the POS IF emulator 1200 may notify the store system 700 of the information. It has been assumed that the shopping-payment management system 500 and the POS IF emulator 1200 are provided at a store as separate devices, and function by communication. However, a POS IF emulator system 60, i.e., the POS IF emulator 1200 having the functions of the shopping-payment management system 500, may be also created. Additionally, the functions of the POS IF emulator 1200 or the POS IF emulator system 60 may be integrated into the item tag management system 200.

The POS IF emulator 1200 handles the store information 437 (specifically, has the store information as its ID), whereby the shopping-payment management system 500 may extract the payment information 580 for each store by using the store information 437 contained in the shopping information 430B, and process payment at the POS 710 in the store through this POS IF emulator 1200. It has been assumed that the shopping-payment management system 500 and the POS IF emulator 1200 are located at the same store. However, a retail chain having many stores, such as a major supermarket chain, it is not reasonable for each store to have the shopping-payment management system 500, and integration is desirable in order to effectively analyze a shopping information database 1430.

In this case, the use of a plurality of POS IF emulators 1200 each having the store information 437 as its ID allows the shopping-payment management system 500 to extract the payment information 580 for each store using the store information 437 contained in the shopping information 430B and process payment at the POS in each of a plurality of corresponding stores. In addition, the shopping-payment management system 500 may be installed in a management system for a commercial facility including many retail stores, such as a shopping mall, and this POS IF emulator 1200 may be applied to each retail store. With this configuration, a service can be provided that allows a customer to shop using one common shopping application at any stores in the shopping mall and to automatically make payment at the POS in each store.

FIG. 21 is an example of keyboard input data 1310. In a typical POS system, the POS operator scans items having been put in the shopping cart by the customer one by one and operates the keyboard at the time of payment to register the items and process payment, whereby input key data is generated. The keyboard input data corresponds to the input key data.

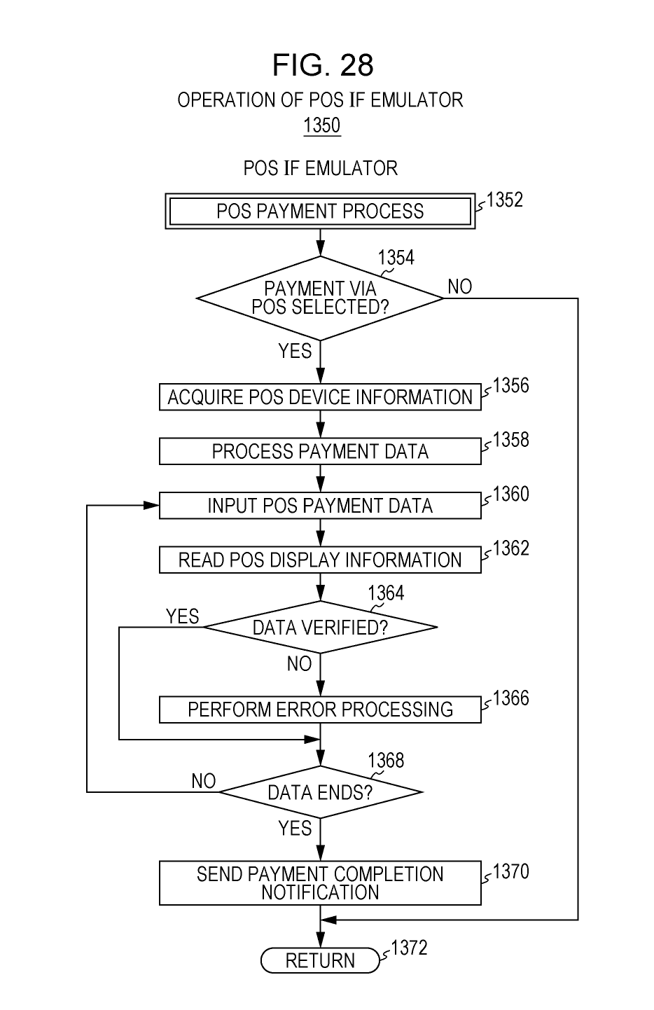

FIG. 28 is a flowchart illustrating an example of the operation of the POS IF emulator 1200. This function is called in the POS payment process in block 1350 of the flowchart of FIG. 27 that illustrates the example of the operation of the shopping-payment management system 500. If payment via the POS IF emulator 1200 is selected in block 1354, in block 1356, the POS IF emulator 1200 reads, via the shopping-payment management system 500, information registered in the POS device information database 3200, such as keyboard-scanner interface information and the POS-application operation procedure for the POS 710 connected to the POS IF emulator 1200. In block 1358, the POS IF emulator 1200 processes the payment information 580 in accordance with the information, thereby creating the keyboard input data 1310 illustrated in FIG. 21. In block 1360, the POS IF emulator 1200 inputs the keyboard input data 1310 to the POS 710 on a line-by-line basis as POS payment data. The POS IF emulator 1200 reads an output from the POS 710 corresponding to the input in block 1362, and compares and verifies the output with the input in block 1364. If the output does not match the input, the POS IF emulator 1200 performs error processing in block 1366. If the output matches the input, the process returns to block 1360, in which the POS IF emulator 1200 inputs the next data line. After finishing inputting the entire data, the POS IF emulator 1200 sends a payment completion notification to the shopping-payment management system 500 in block 1370, and terminates the process.

Examples of purchase through a bookmark include using this function in a large shopping mall. After starting the shopping application in the mobile phone 300, a customer scans QR codes on the item tags 100 of items that the customer wishes to buy at each store while window shopping. The customer bookmarks items that they are undecided as to whether to buy. When the customer selects payment after finishing their shopping, the shopping information 430B is sent to a payment system (the store system 700) of each store, and is processed therein. The amount is charged to the credit card registered in advance (in the user registration information database 900), and the customer can collectively pick up the items at the item pickup counter at the entrance of the shopping mall or at the back drive-through window. The items are also delivered to the address registered in advance (in the user registration information database 900) if the customer specifies delivery.

After finishing shopping at the shopping mall, the customer now wishes to buy the item that they were interested in but the store is on the opposite side of the mall, requiring a ten-minute walk. Thus, the customer starts the shopping application in the mobile phone 300 and activates the bookmark function, upon which information about the item is displayed. If the customer specifies the quantity and pushes a “BUY” button, the shopping information 430D is sent to the payment system (store system 700) of the store and is processed therein. After a while, the customer receives the item at the pickup counter before going home.

One week later, this customer wishes to buy another item that they were interested in. However, the shopping mall is 100 kilometers away, and thus the customer is unable to go there now. Thus, the customer starts the shopping application in the mobile phone 300 and activates the bookmark function, upon which information about the item is displayed. If the customer inputs the quantity, specifies home delivery, and then pushes the “BUY” button, the shopping information 430D is sent to the payment system (store system 700) of the store and is processed therein. The next day, the item is delivered to the customer's home. The customer sees the leaflet delivered with the item and realizes that the price has risen back to the normal price. However, the customer was able to buy the item at the price that was offered when the item was bookmarked.

Two weeks later, this customer wishes to buy this same item again, and uses the bookmark function. This time, this customer was able to buy the item at a lower price than the bookmarked price for some reason. The next day, the customer attempts to buy this item again. However, expiration of the valid period is displayed and the customer cannot buy the item.

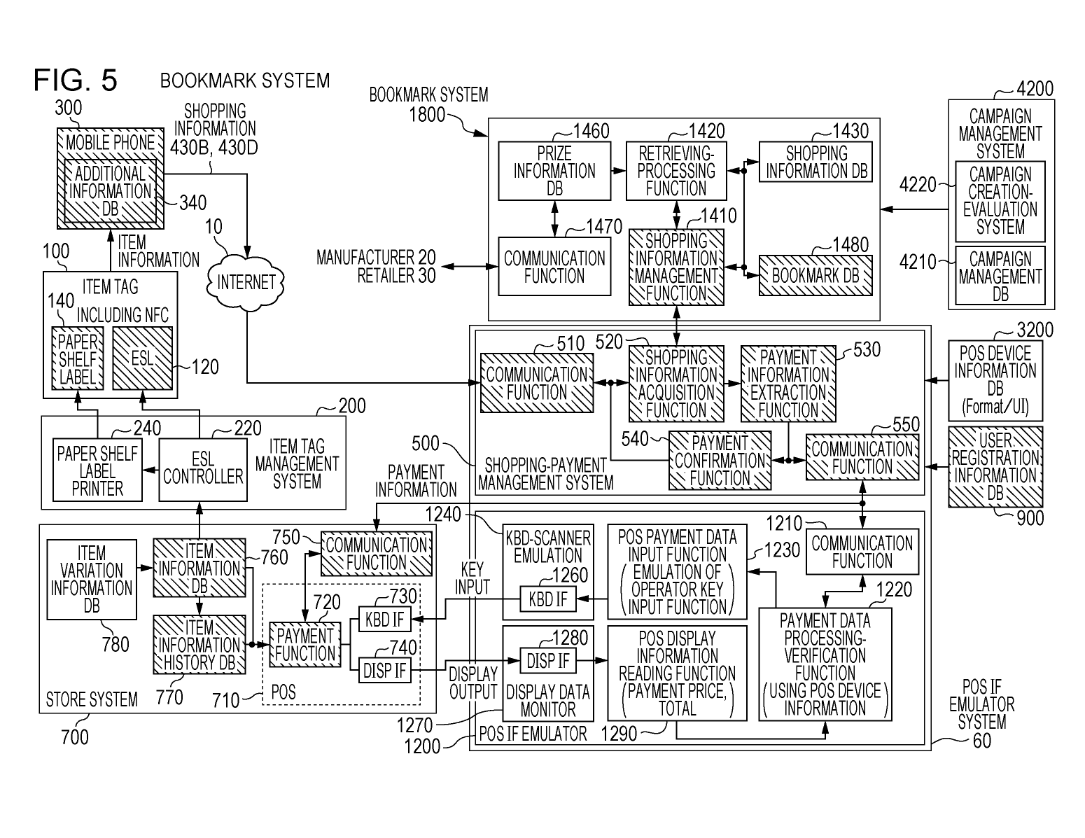

As described above, when the bookmark function is provided as an additional function, the bookmark system 1800 is added as one of the extended shopping processing systems 1400. FIG. 5 is a diagram with hatched blocks that function in the mobile shopping system that uses a bookmark system. The bookmark function has two sub-functions of storing item information as a bookmark during shopping, and of loading the stored bookmark.

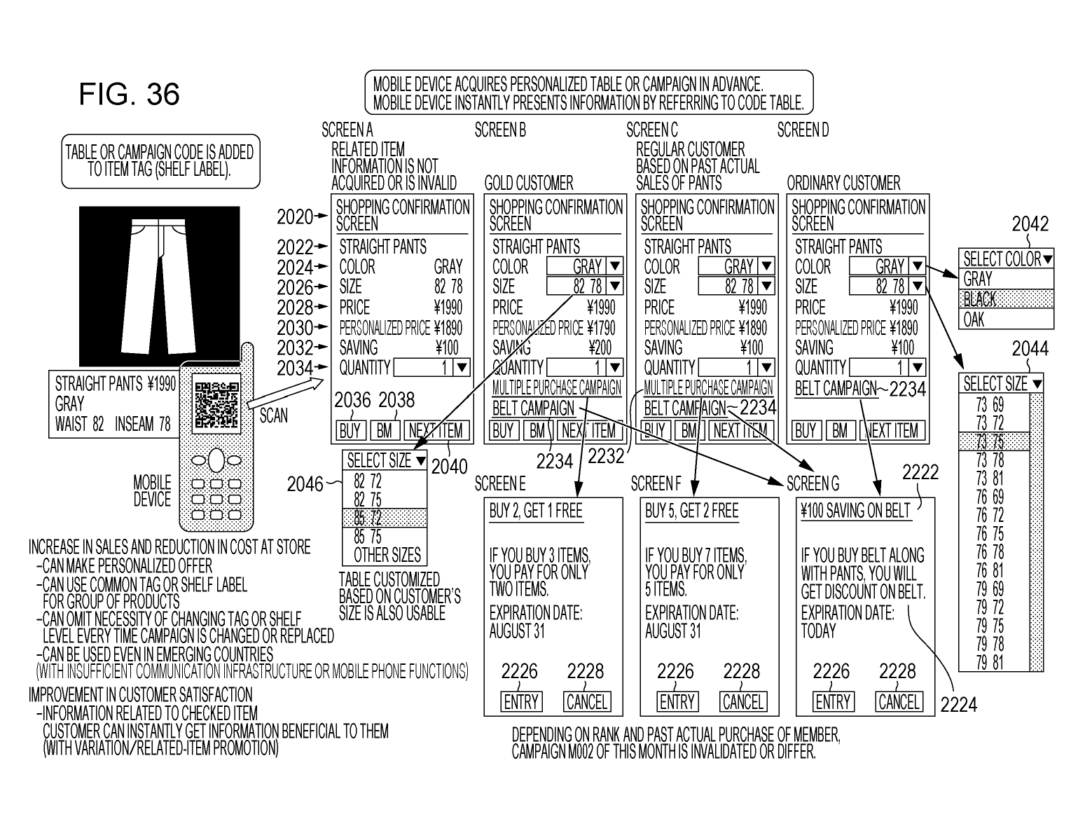

As illustrated in FIG. 36, when the mobile phone 300 displays the acquired item information 760 on its screen, it also displays a button 2036 for specifying the ordinary purchase operation and a button 2038 for specifying the bookmark operation. If the mobile phone 300 acquires the item information 760 from the item tag 100 and the customer selects this bookmark operation, the line 449 of the shopping information 430A is created and stored. Since bookmarking is performed generally during ordinary shopping, shopping information such as the shopping information 430A stored in the mobile phone 300 before payment includes information related to ordinary shopping and a bookmark.

At the time of payment, the mobile phone 300 sends shopping information 430B, in which payment time information is recorded as the payment date and time 439 of the created shopping information 430A, to the shopping-payment management system 500. The shopping information acquisition function 520 of the shopping-payment management system 500 supplies the received shopping information 430B to a shopping information management function 1410 of the bookmark system 1800. The shopping information management function 1410 extracts the bookmark information 449, and stores the bookmark information 449 in the bookmark database 1480.

In a case of purchasing a bookmarked item, the mobile phone 300 reads the stored bookmark information 449 (the line 449 of the shopping information 430A), and creates the shopping information 430C by adding the purchase date and time 438, the quantity 440, and the subtotal 441 to the bookmark information 449. After starting a payment process, the mobile phone 300 sends the shopping information 430D containing the time in the payment date and time 439 to the shopping-payment management system 500. The shopping-payment management system 500 supplies the shopping information 430D to the shopping information management function 1410 of the bookmark system 1800. The shopping-payment management system 500 reads the bookmark information 449 stored in the bookmark database 1480, and verifies whether or not the read bookmark information 449 is valid.

Since the bookmark information 449 contains valid conditions, such as until when the offer is valid, up to how many items the customer can buy, and up to how many times the customer can buy the item, verification is performed here. The shopping information management function 1410 of the bookmark system 1800 deletes one or more unverifiable items from the shopping information 430D. The mobile phone 300 is later notified of the one or more shopping items that do not meet the valid conditions and a payment result. If the one or more unverifiable items are deleted from the shopping information 430D, information about an alternative campaign or promotion acquired from a campaign management system 4200 may be additionally sent to the mobile phone 300 when the payment result is sent thereto. When displaying the payment result on its screen, the mobile phone 300 may display the alternative campaign or promotion.

In the shopping-payment management system 500, the shopping information acquisition function 520 receives the shopping information 430D from the shopping information management function 1410. The payment information extraction function 530 creates the payment information 580, which is then sent to the store system 700 via the communication function 550. The store system 700 includes an item information history database 770, and processes payment in accordance with item information corresponding to the bookmark date and time 585 of the payment information 580.

The payment result is returned to the mobile phone 300 via the shopping-payment management system 500. In this manner, a series of operations is finished. It is assumed herein that the store system 700 includes the item information history database 770. However, when the third party provides the bookmark function as its service, there may be an option in which the third party may bear or gain the difference between the bookmarked price and the current price, and the item information history database 770 may be omitted at the store. For example, when the paid price is higher than the bookmarked price, the third party bears the difference; whereas when the paid price is lower than the bookmarked price, the third party gains the difference. This third party can take such a risk because they earn profits from performing marketing and promotion based on bookmark information of customers.

The bookmark information 449 contains the price 435 that was offered when the mobile phone 300 acquired the item information 760 from the item tag 100 and bookmarked the item information 760 and contains the bookmark date and time 442, allowing a customer to later purchase the item at the price offered at the time of bookmarking. In addition, the item information 760 contains the valid conditions 767, which are stored as the valid conditions 443 in the bookmark information 449. Thus, purchase through a bookmark may be constrained.

Upon finding an unverifiable item due to the constraint on purchase through a bookmark, the shopping-payment management system 500 may make an inquiry to the campaign management system 4200 to acquire campaign information applicable to the mobile phone 300, and may send the acquired campaign information to the mobile phone 300. For example, this campaign information may represent a discount coupon or an alternative item.

It is not reasonable for a retail chain including many stores, such as a major supermarket chain, to have the shopping-payment management system 500 and the bookmark system 1800 at each store, and thus integration is desired. The shopping-payment management system 500 can extract the payment information 580 for each store by using the store information 437 contained in the shopping information 430. Accordingly, the shopping-payment management system 500 and the bookmark system 1800 may be constructed as cloud systems, thereby enabling payment through bookmark at a plurality of corresponding stores.

In addition, the shopping-payment management system 500 and the bookmark system 1800 may be installed in a management system for a commercial facility including many retail stores, such as a shopping mall, and a service may be provided which enables payment through a bookmark at any retail store in the shopping mall. This allows a customer to purchase an item using a bookmark without re-visiting the store if they bookmark, when they visit the store, an item that they are undecided as to whether to buy the item or an item that they may wish to buy after comparing the item with another item of another store. Thus, a service that is highly convenient to customers may be provided particularly in a huge shopping mall developed in a huge space, such as one in the United States.

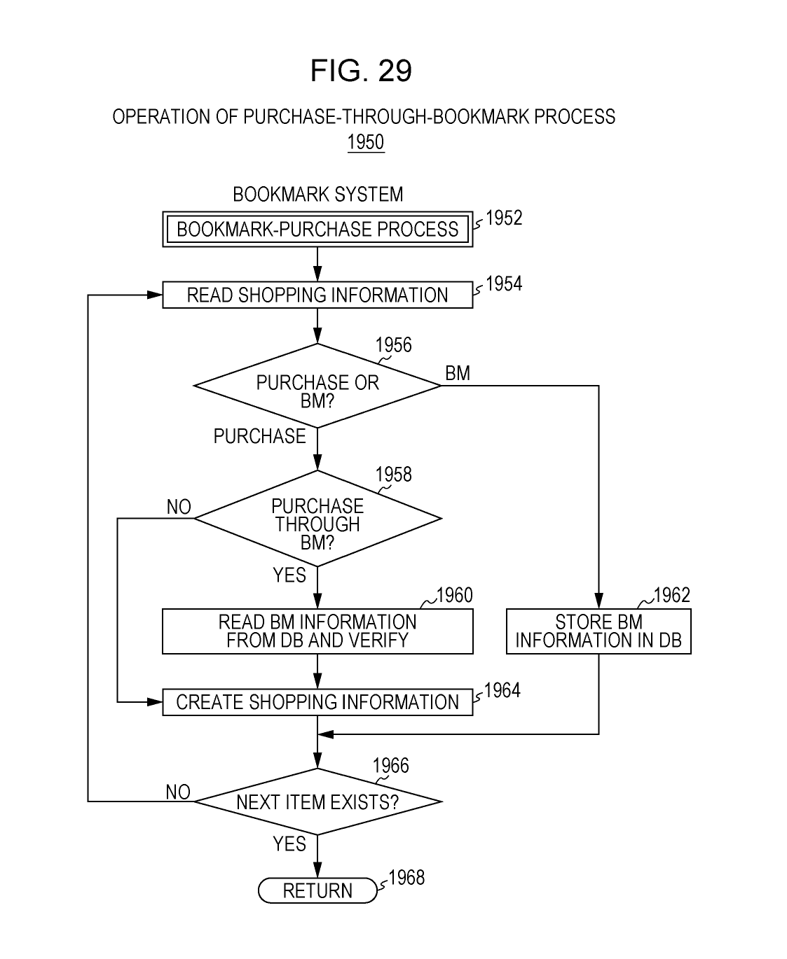

FIG. 29 is a flowchart illustrating an example of the operation of the bookmark system 1800. Upon a bookmark process being called in block 1950 of the flowchart of FIG. 27 for the shopping-payment management system 500, the bookmark system 1800 acquires the shopping information 430B from the shopping-payment management system 500 in block 1954. The bookmark system 1800 extracts the bookmark information 449 from the shopping information 430B, and determines whether a to-be-processed piece of shopping information contained in the shopping information 430B indicates bookmarking, purchase through a bookmark, or ordinary purchase in block 1956 and 1958.

In a case of bookmarking in block 1956, the bookmark system 1800 stores the bookmark information 449 in the bookmark database 1480 in block 1962. If another item to be processed exists in block 1966, operations from block 1954 are repeated for the next item. In a case of purchasing a bookmarked item in block 1958, the bookmark system 1800 reads the bookmark information 449 stored in the bookmark database 1480, and verifies the acquired shopping information 430D against the bookmark information 449 in block 1960. The bookmark system 1800 creates updated shopping information 430D, by deleting one or more unverifiable items, in block 1964. The process proceeds to processing for the next item in block 1966. In a case of ordinary purchase in block 1958, the shopping information 430D is used without modification. The process proceeds to processing for the next item in block 1966.

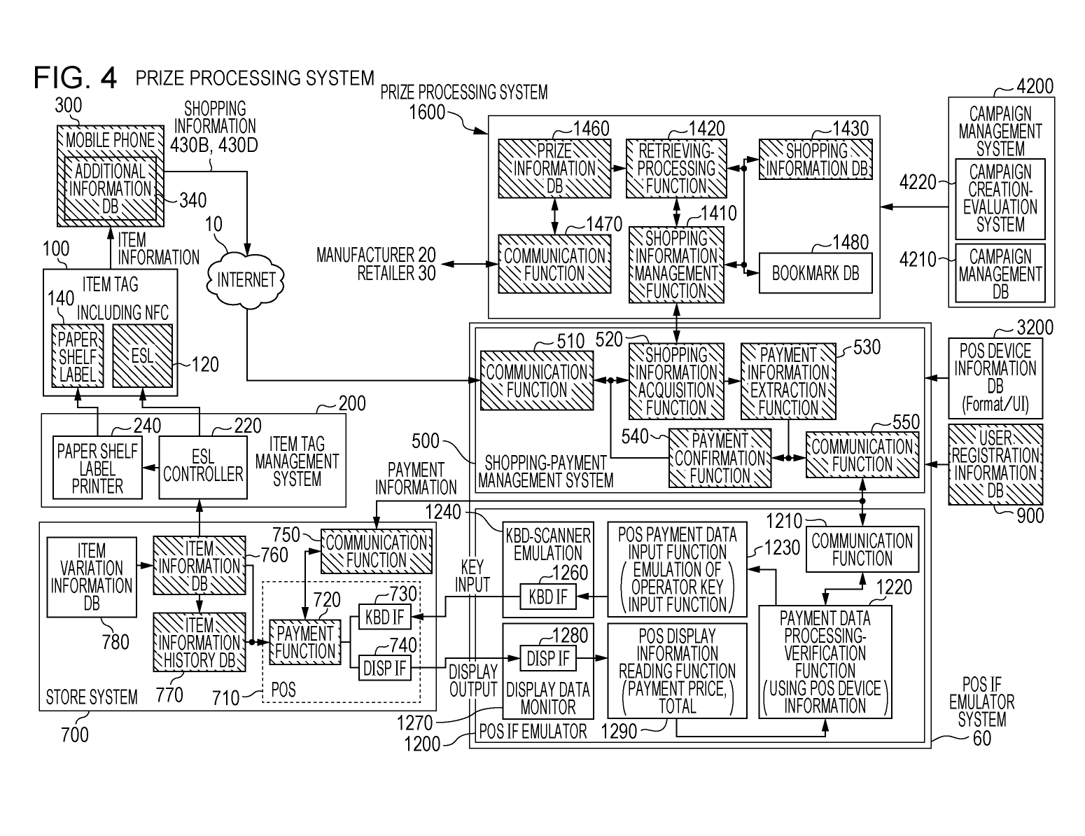

After finishing processing all items, the bookmark system 1800 supplies the shopping information 430D to the shopping-payment management system 500, and then terminates the process. When the prize function is provided as an additional function, the prize processing system 1600 is added as one of the extended shopping processing systems 1400. FIG. 4 is a diagram with hatched blocks that function in the mobile shopping system that uses a prize processing system.

When the customer acquires the item information 760 from the item tag 100 and then selects to purchase the item with their mobile phone 300, the mobile phone 300 creates the shopping information 430A. Once the customer finishes shopping, the mobile phone 300 performs a payment process, in which the mobile phone 300 creates the shopping information 430B and sends the shopping information 430B to the shopping-payment management system 500.

The shopping information acquisition function 520 of the shopping-payment management system 500 supplies the received shopping information 430B to the shopping information management function 1410 of the prize processing system 1600. The shopping information management function 1410 updates the shopping information database 1430. A retrieving-processing function 1420 of the prize processing system 1600 searches the acquired shopping information 430B undergoing the payment process for a prize target item having been pre-registered to a prize information database 1460 by the manufacturer 20 or retailer 30 via a communication function 1470.

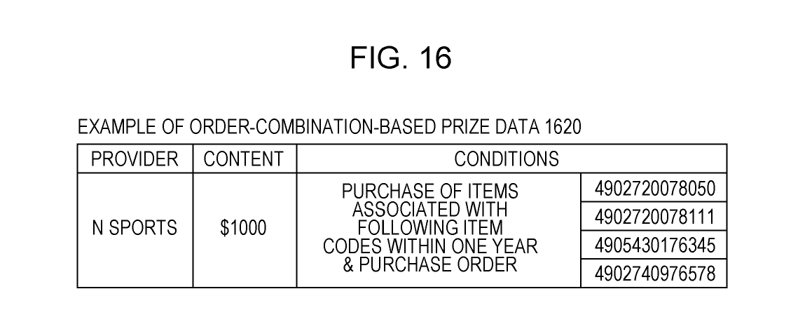

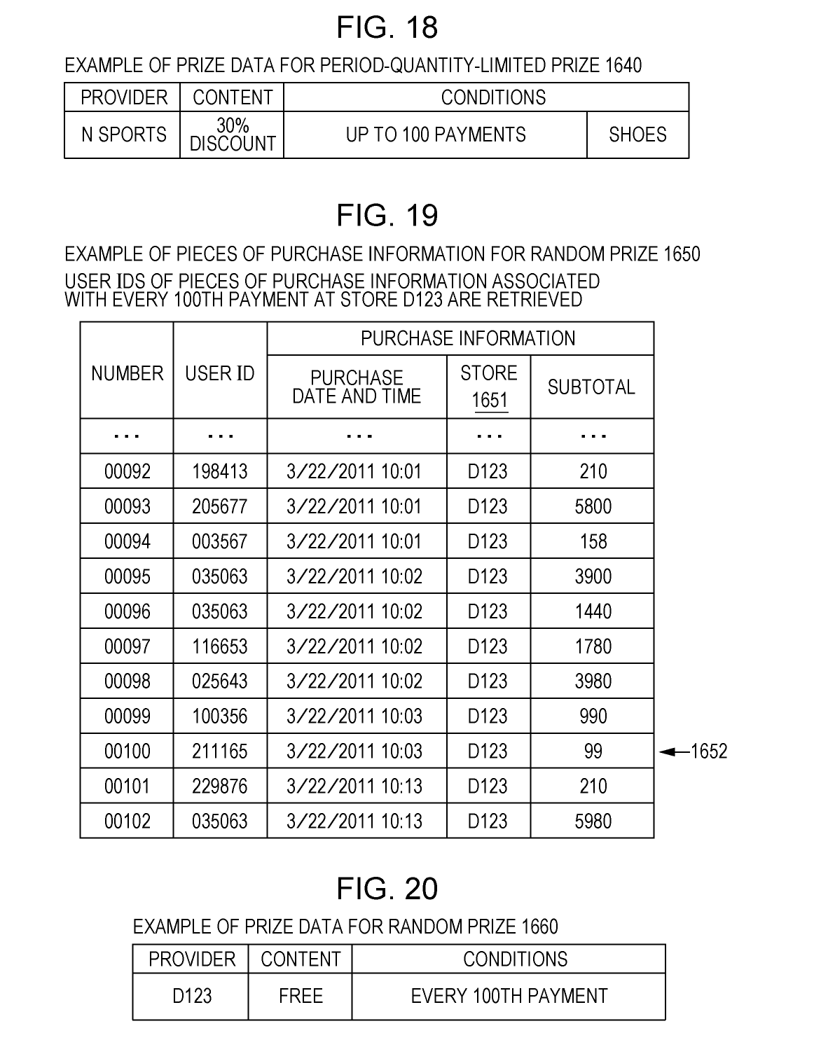

If a prize target item is found and a piece of shopping information associated with the corresponding user ID in the shopping information 430B satisfies conditions (such as 1620 of FIG. 16, 1640 of FIG. 18, or 1660 of FIG. 20) described by prize data, the retrieving-processing function 1420 performs a prize process based on the prize data. After finishing the prize process, the retrieving-processing function 1420 notifies the mobile phone 300 and the shopping-payment management system 500 of winning of the prize, and sends the shopping information 430B, in which a discount for the won prize is reflected, to the shopping-payment management system 500. The shopping-payment management system 500 then performs a payment process.

Types of the prize include discount and money/item. In a case of discount, the retrieving-processing function 1420 acquires discount data from the conditions (such as 1620, 1640, or 1660) described by the prize data, and corrects the shopping information 430B. In a case of money/item, the retrieving-processing function 1420 performs corresponding processing, and notifies the mobile phone 300. This notification may be made through a screen, sound, or the like. That is, upon requesting a payment process, the mobile phone 300 is notified of prize winning information through a screen or sound. Then, the mobile phone 300 receives the payment result in which the prize is reflected.

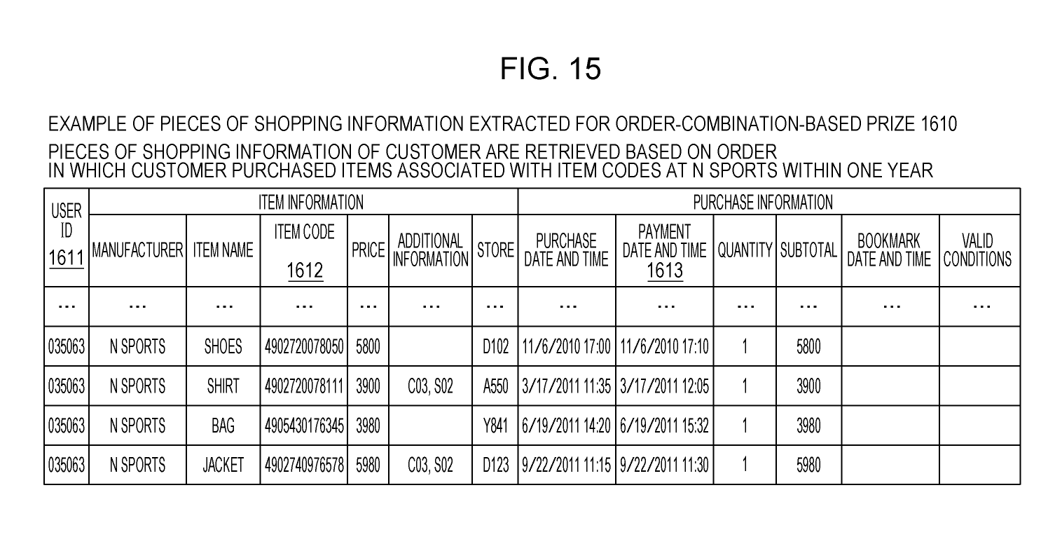

Various prizes sponsored by the manufacturer 20 and the retailer 30 are registered to the prize information database 1460. FIG. 15 illustrates an example of pieces of shopping information having won the order-combination-based prize of a manufacturer. For example, the order-combination-based prize indicates that a customer may get a prize $1000 ($100) from a manufacturer if within one year they purchase items of the manufacturer in the purchase order (combination) predetermined by the manufacturer. FIG. 15 illustrates the example in which a customer with the user ID 1611 “035063” wins $1000 because it is registered in the shopping information database 1430 that the customer has purchased items with four specified item codes 1612 (shoes, a shirt, and a bag) within one year when the customer pays for a jacket (with the item code 1612 “4902740976578”) of N sports, and the order in which the items were purchased satisfies the example of the prize data of FIG. 16. Although the purchase order is specified here, a $100 prize may be offered for a specified combination.

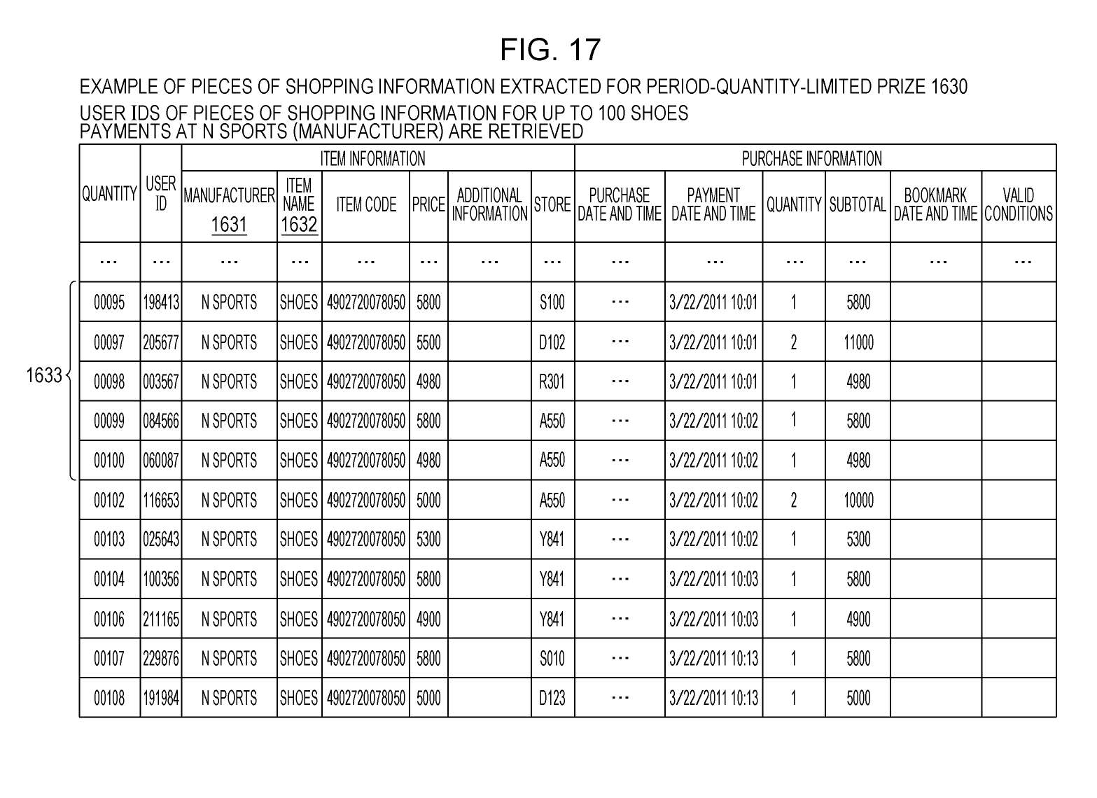

FIG. 17 illustrates an example of pieces of shopping information having won a quantity-limited prize of a manufacturer. For example, the quantity-limited prize indicates that first 100 payments for a certain item are discounted by 30%. FIG. 17 is an example in which customers with the respective user IDs 1611 win a 30% discount because the number of payments registered in the shopping information database 1430 is equal to 100 or less when the customers purchase shoes of N sports (the manufacturer 1631 indicates N sports and the item name 1632 indicates shoes), which satisfies the example of prize data of FIG. 18. The period may be specified in this example instead of the quantity.

FIG. 19 illustrates an example of pieces of shopping information having won a random prize of a retailer. For example, the random prize indicates that shopping at a certain retail store is free up to $100 for one out of a hundred payments or is completely free for one out of a thousand payments. FIG. 19 illustrates the example in which a customer with the user ID 1611 “211165” wins a 100% discount because the customer's payment is the 100th payment in the shopping information database 1430 when the customer makes payment for an item at a store with the store ID 1651 “D123”, which satisfies the example of prize data of FIG. 20.

In addition, conditions (such as 1620, 1640, or 1660) described by the prize data may be purchasing multiple different items, the order of the purchase date and times 438 of items, purchasing at multiple different stores, purchasing items of multiple different manufacturers, the purchase date and time 438 within a predetermined range, the randomly selected prize, and the limited number of wins, and combinations thereof.

A management system for a commercial facility including a plurality of stores, such as a shopping mall, may install the mobile shopping system including this prize processing system 1600. This enables a prize-related event, such as a year-end lottery event or stamp rally by purchasing at a plurality of stores, to be electronically performed without in advance printing and distributing lottery tickets and application tickets.

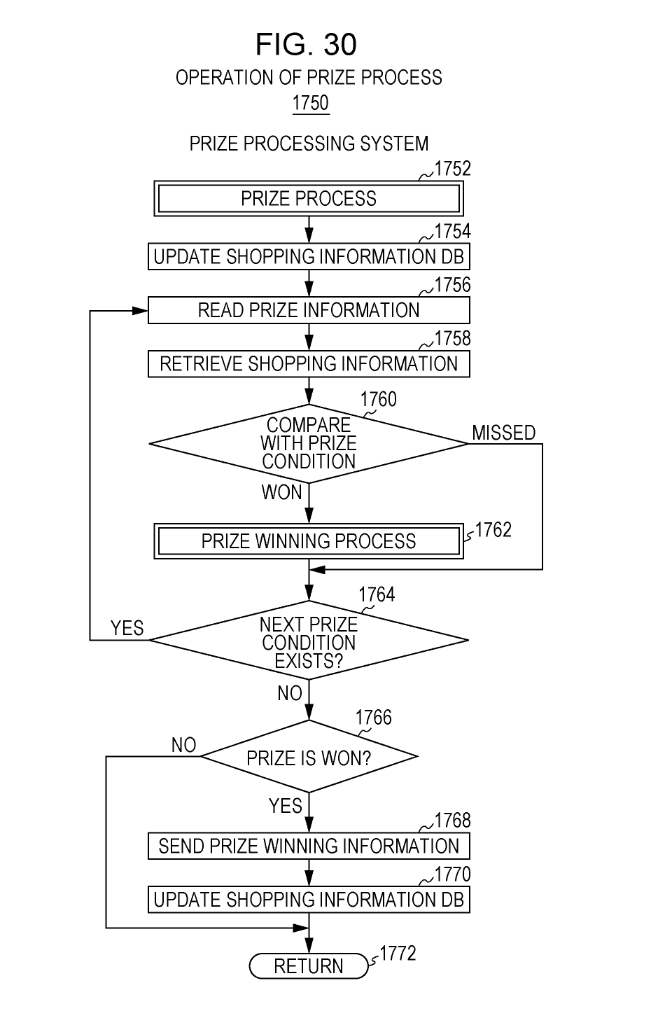

FIG. 30 is a flowchart illustrating an example of the operation of the prize processing system 1600. Upon the prize process being called in block 1750 of the flowchart of FIG. 27 for the shopping-payment management system 500, the shopping information management function 1410 stores the acquired shopping information 430B to update the shopping information database 1430 in block 1754. In block 1756, the retrieving-processing function 1420 loads conditions (such as 1620, 1640, or 1660) described by the prize data from the prize information database 1460, and searches the shopping information database 1430 in block 1758.

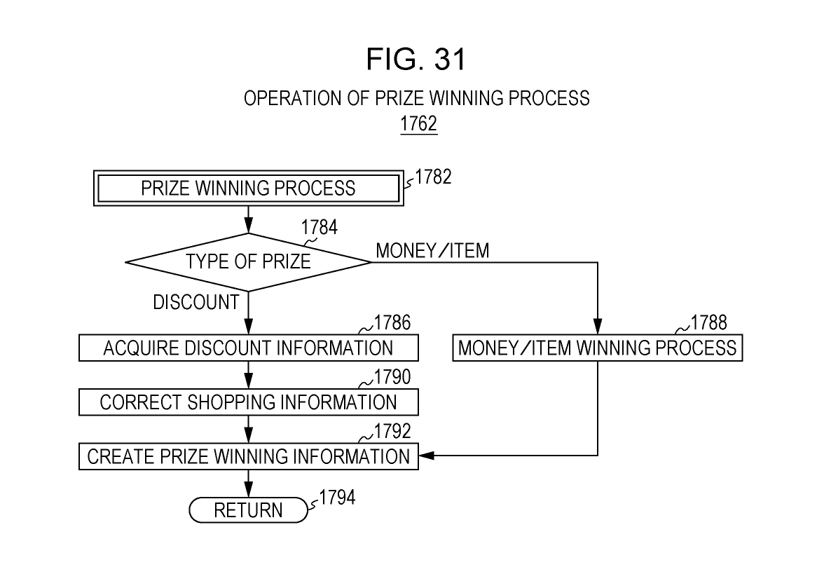

If a prize is won in block 1760, a prize winning process is performed in block 1782 of FIG. 31. If the prize is discount in block 1784, discount data is acquired from the conditions (such as 1620, 1640, or 1660) described by the prize data in block 1786. In block 1790, the shopping information 430B is corrected to apply the discount thereto, whereby prize winning information to be sent to the mobile phone 300 is created in block 1792.

If the prize is money/item, a money/item winning process (such as shipping process) is performed in block 1788. The process then proceeds to block 1792.

If the prize is not won in block 1760 or after the prize winning process ends, the prize for the next item is checked in block 1764. After finishing checking all items, if the prize is won in block 1766, the prize winning information created in block 1792 is sent to the mobile phone 300. The shopping information database 1430 is updated in block 1770. The prize processing system 1800 supplies the shopping information 430B to the shopping-payment management system 500.

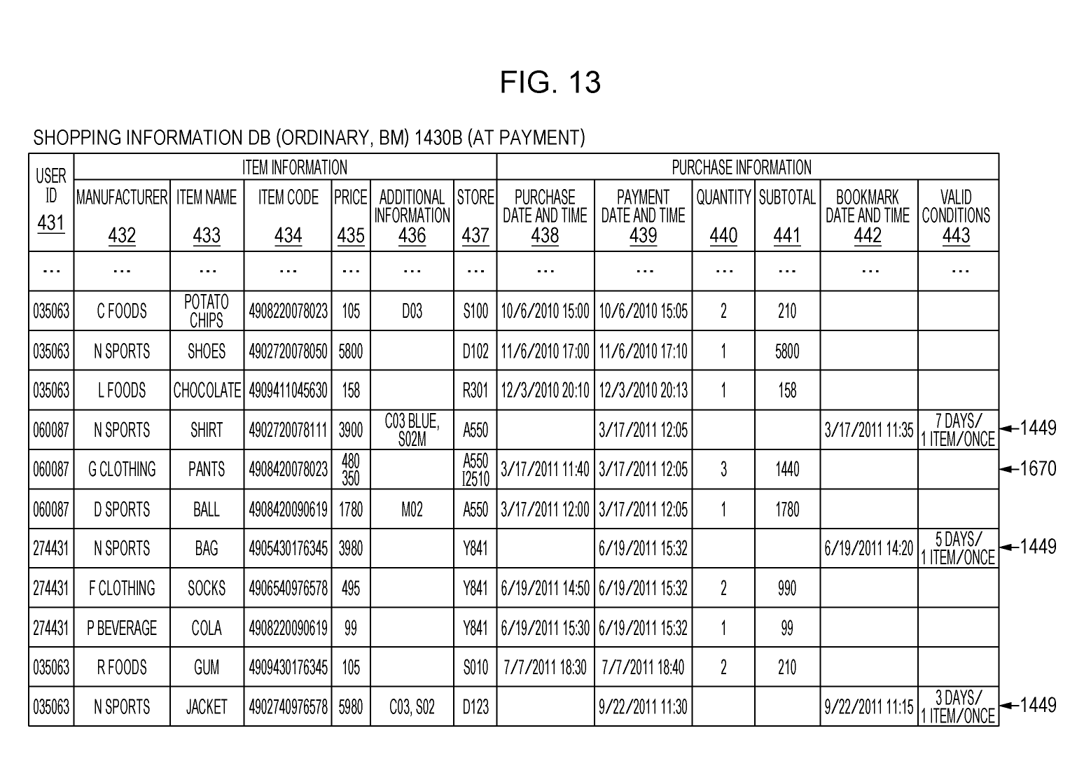

Examples of the prize function may include providing an item at a lower price using an affiliate model. In this model, a customer scans the item tag 100 at a certain store but the prize processing system 1600 searches for another store offering a lower price, and the customer purchases the item at the other store. The certain store obtains an introduction fee from the other store where the item is purchased. Since the item information 760 contains the item code 763 and the store code 766, the prize processing system 1600 can grasp at which store what item is scanned by the mobile phone 300. For example, if a customer scans an item, selects home delivery, and makes payment using the shopping application, the shopping information 430B is sent to the prize processing system 1600. The prize processing system 1600 searches for another retail store registered as an affiliate store in advance to the prize information database 1460. As in the example of a line 1670 of the shopping information database 1430B of FIG. 13, the store offering the lowest price and the price at the store are appended to the data of the price 435 and the store information 437 of the shopping information 430B. In this example, the store information “12510” and the price “350” are appended.

When extracting the payment information 580 from the shopping information 430B, the shopping-payment management system 500 creates a line 590 of the payment information 580, in which an affiliate mark (e.g., “A”) is appended to the ordinary payment registration information 586 acquired from the user registration information database 900. Also, the shopping-payment management system 500 creates the payment information 580 in which the user ID 581 of the original payment information 580 is modified to the store ID (A550 in this example) of the store where the item was scanned, the price 583 thereof is modified to the appended price data (¥350 in this example), the payment registration information 586 thereof is modified to the payment account number (the payment account aaaaaaaa in this example) registered in the prize information database 1460 as the affiliate store and a delivery address of the customer (not illustrated in this example) (typically one piece of payment information 580 is divided into to two pieces of payment information 580). The shopping-payment management system 500 notifies the mobile phone 300 that the item is provided at a lower price, and sends these pieces of payment information 580 to the store systems 700 of the respective stores (the line 590 of the payment information 580 is sent to the store A550 where the item was scanned, whereas the line 591 is sent to the store 12510 registered as the affiliate store) for payment.

The store where the item was scanned processes payment using a method pre-specified by the customer in the user registration information database 900. The store that sold the item charges the amount obtained by subtracting a predetermined fee from the sales to the payment account number of the store where the item was scanned. In this manner, a customer can purchase the same item at a lower price.

There are recently increasing undesirable customers who scan a barcode of the item at a store in order to purchase an item on an EC site offering the lowest price. A retail store can gain a fee by providing the similar service to them, without a complicated purchase procedure. Also, the retail store may reduce the stock of items highly involving such a tendency. When an additional information service for an item purchase of which is under consideration is provided as an additional function, an additional information service processing system is added as the extended shopping processing system 1400.

Herein, a description will be given of an item variation management system 2000 serving as a first additional information service processing system, and of a campaign information system 2200 serving as a second additional information service processing system.

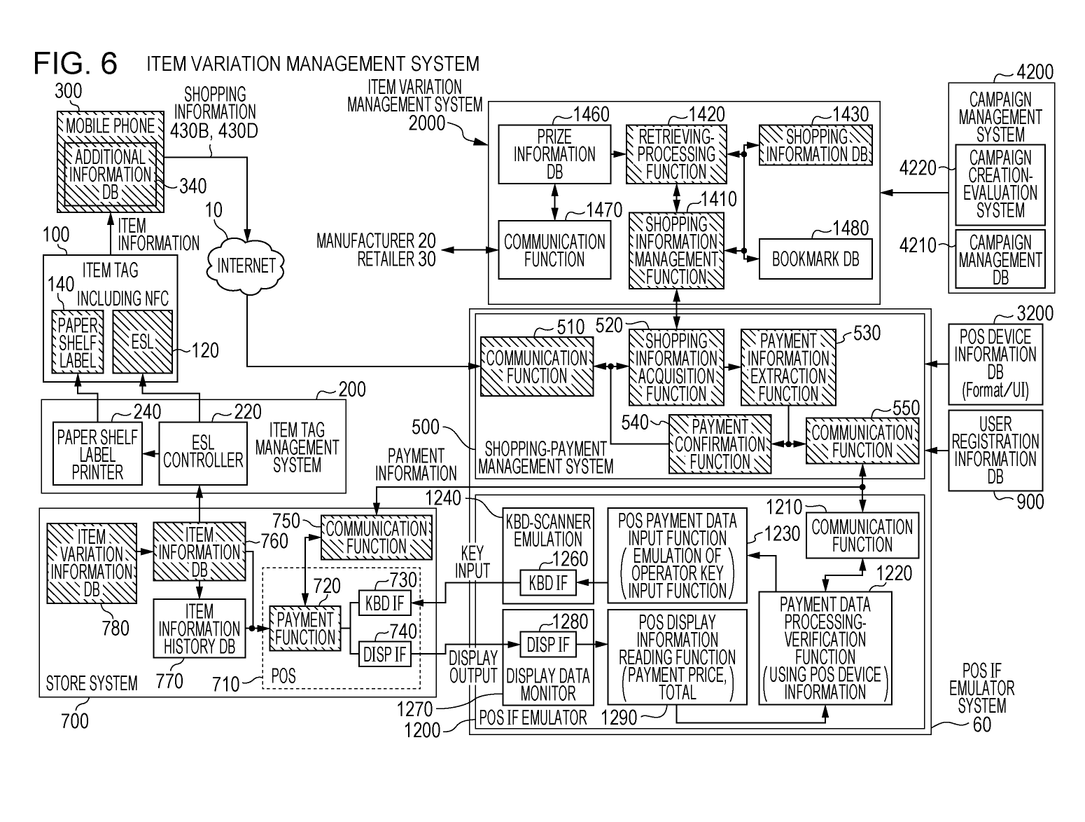

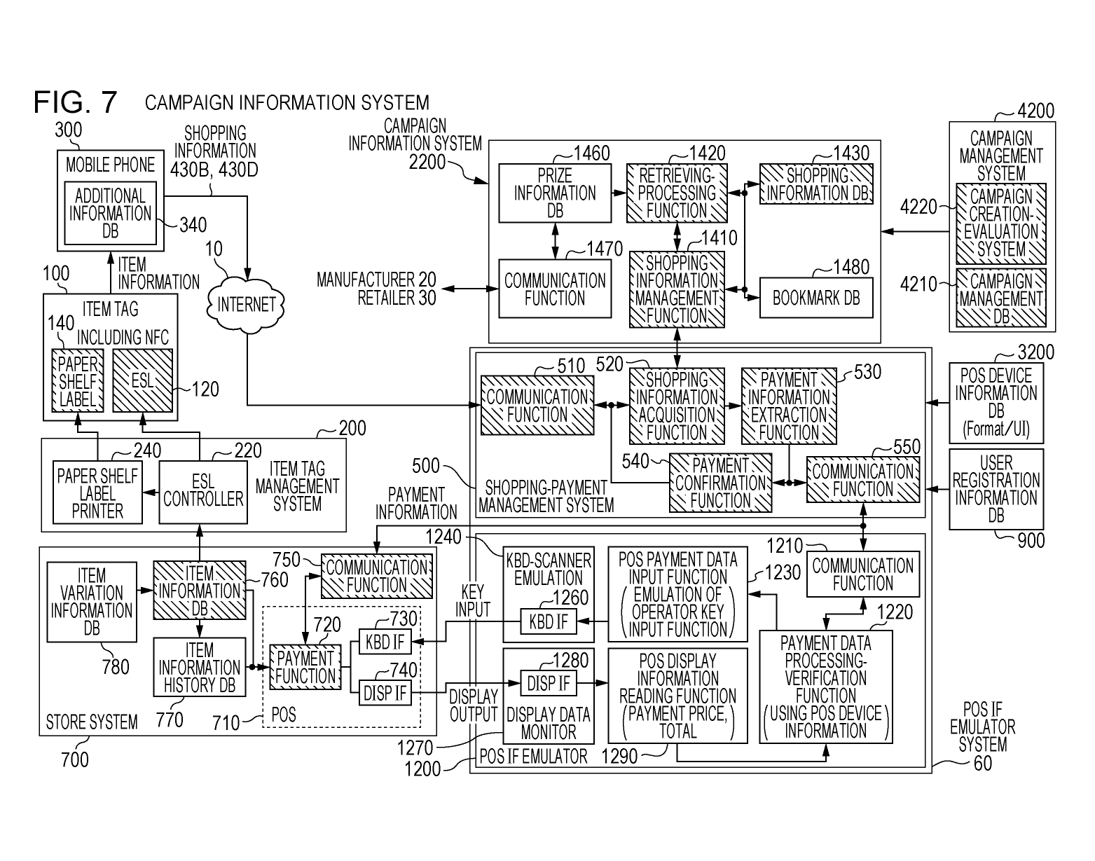

FIGS. 6 and 7 are diagrams with hatched blocks that function in the mobile shopping system that uses the item variation management system 200 and the campaign information 2200, respectively.

Here, additional information 765 is item variation information in the item variation management system 2000 (the first additional information service processing system). The item variation information is the identifier of information on variations (options, customization, or selection of a single or multiple options) of an item (shopping target item) whose item information 760 has been acquired. By additionally specifying variations of the item from among the acquired item variation information, there can be created shopping information 430 that specifies a partial modification of basic information of the acquired item information 760 (e.g., when the shopping target item is a blue shirt, the color of the shirt is changed to red) or additional options for the item (e.g., when the shopping target item is ice cream, nut and chocolate toppings are added).

Herein, examples of the item variation information include the following. When the shopping target item is clothing and there are variations of different sizes (such as sizes S and L) and/or colors/patterns (such as red, and black and white strip) from that of the shopping target item (e.g., of blue and size M) whose item information 760 is acquired with the mobile phone 300, the item variation information may be the identifier of a size code table representing kinds of size variations of the item or of a color code table representing kinds of color/pattern variations of the item. In addition, when the shopping target item is food (e.g., steak), the item variation information is the identifier of a side dish selection list (including baked potato, rice with butter, heated vegetables, and mashed potato), or the identifier of a salad dressing selection list (select one from vinaigrette, blue cheese, honey mustard, ranch, thousand island, and so forth).

Furthermore, when the shopping target item is ice cream, the item variation information is the identifier of a flavor check list enabling selection of zero or more flavors (zero or more flavors are selectable from almond, cashew, fruits, marshmallow, chocolate, and so forth). Such an item variation identifier (additional information 765) is rarely exclusively used for one specific item, and may be applicable to all similar items handled at the store. The same identifier (additional information 765) can be used for a plurality of pieces of item information 760.

For example, when items handled at a store are clothing, the size code table identifier is applicable to sweaters, coats, shirts, and so forth in common. In addition, for example, when the items handled at a store are foods, the identifier of the side dish selection list is applicable to many main dishes (various steaks and various fries) in common. Depending on items specifiable by using additional information, the price may increase or decrease. For example, in a case of clothing with sizes XS, S, M, L, XL, the price for sizes XS to L may be uniform but the price for size XL may increase by 100 yen. In addition, for example, in a case of foods, the price may increase or decrease depending on the kinds of the side dish (e.g., a 100 yen discount for baked potato, a 100 yen additional charge for mashed potato, and no additional charge for heated vegetables). In a case of ice cream, the additional charge from 0 to 300 yen may be individually set in accordance with the kinds of topping. In the campaign information system 2200 (the second additional service processing system), the additional information 765 is campaign information. The campaign information is the identifiers of various campaigns and promotions related to a shopping target item whose item information 760 has been acquired with the mobile phone 300.

For example, an identifier specifies target items of member discount, target items of a fall-clothing clearance sale, target items of a rainy day discount, target items of a multiple purchase sale, target items of a combination discount, or target items of questionnaire. The identifier (additional information 765) of the campaign information is used for specifying target items of the campaign. However, the identifier does not uniformly define the content of the campaign. That is, different campaign contents may be provided depending on the mobile phone 300 that acquires the additional information 765. For example, when the campaign information identifier is a winter-clothing clearance sale, a campaign offering different discount rates (such as 10%, 20%, and 30%) may be provided depending on the past shopping activities of the user of the mobile phone 300.

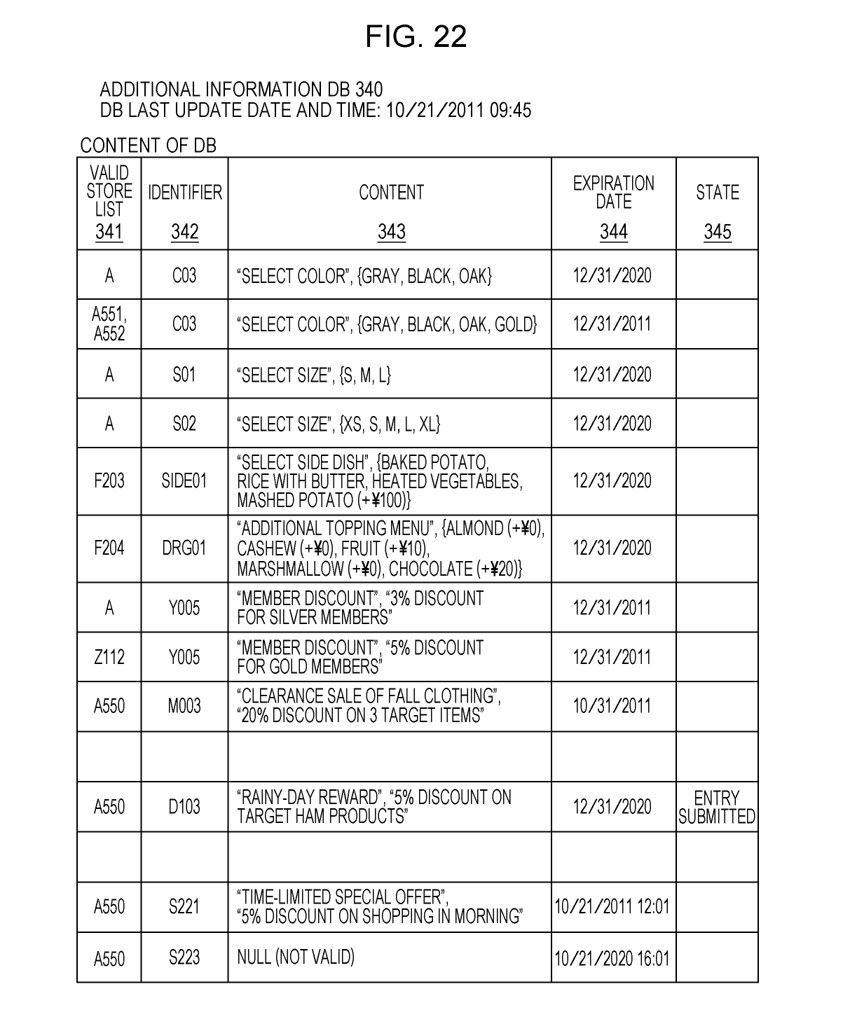

Now, the operation of the mobile phone 300 when the additional information service processing system is installed will be described in detail with reference to FIG. 26. The mobile phone 300 acquires the item information 760 (strictly speaking, one record associated with the item stored in the item information database 760) including the additional information 765 from the item tag 100. With reference to the additional information database 340, the mobile phone 300 acquires content 343 associated with an identifier 342 that is valid (regarding the valid store list 341 and the expiration date 344 in FIG. 22) in the store associated with the additional information 765, and displays the item information 760 and the acquired content 343 on the screen of the mobile phone 300 (block 358 of FIG. 26). If the customer operates the content corresponding to the additional information 765 displayed on the mobile phone 300, the mobile phone 300 records information about the customer's operation in the shopping information 430A (block 364 of FIG. 26). In response to an operation for completing shopping (block 366 of FIG. 26), the mobile phone 300 sends the shopping information 430B to the shopping-payment management system 500 via a communication network, such as the Internet 10, (block 368 of FIG. 26), thereby allowing the customer to purchase the item specified by the additional information 436 of the shopping information 430B.

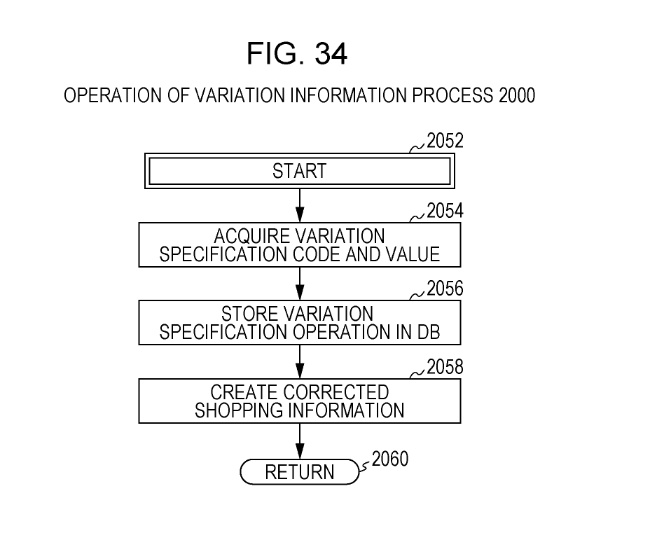

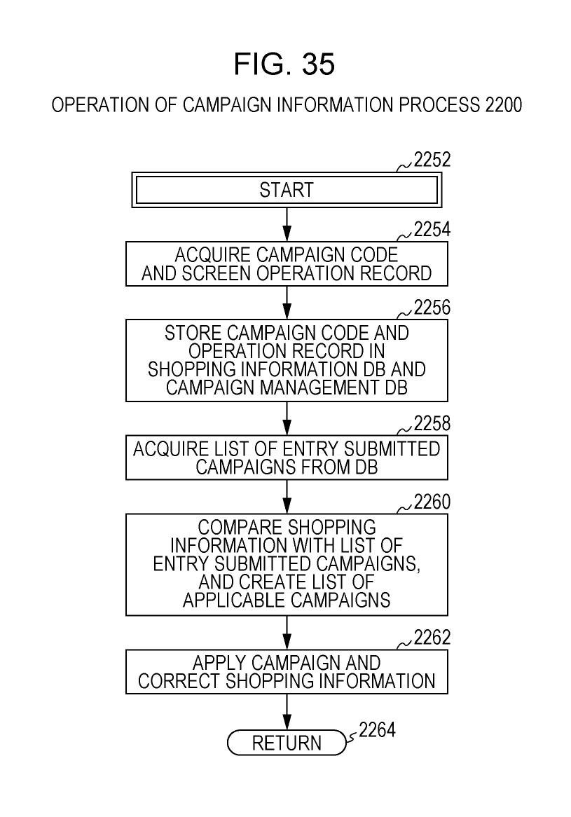

Next, the additional information service processing systems (such as the item variation management system 2000 and the campaign information system 2200) will be described with reference to FIGS. 34 and 35, respectively. Here, FIGS. 34 and 35 are flowcharts 2050 and 2250 of examples of the operations of the item variation management system 2000 and the campaign information system 2200, respectively. In the additional information service processing systems (such as the item variation management system 2000 and the campaign information system 2200), the shopping information management function 1410 acquires the shopping information 430B from the shopping-payment management system 500 (block 2054 of FIG. 34 and block 2254 of FIG. 35). The retrieving-processing function 1420 records the additional information 765 contained in the shopping information 430B in the shopping information database 1430 (block 2056 of FIG. 34 and block 2256 of FIG. 35), and performs corresponding processing.

When the additional information service processing system is the item variation management system 2000, in the corresponding processing, the retrieving-processing function 1420 confirms that the acquired additional information 765 and parameters specified in the operation record are valid as variation information of the item with reference to the item variation information database 780 of the store corresponding to the store code 437 of the shopping information 430B if necessary. The retrieving-processing function 1420 edits the record of the shopping information 430B in accordance with the specified additional information 765 in block 2058 of FIG. 34 by changing the item information 760 to one for the item variation indicated by the specified parameter. Depending on kinds of the additional information 765, an additional charge or discount may occur. Thus, the price 435 of the shopping information 430B may be modified.

When the additional information service processing system is the campaign information system 2200, in the corresponding processing, the retrieving-processing function 1420 stores the acquired additional information 765 and operation record in the shopping information database 1430 and the campaign management database 4210 of the campaign management system 4220 in block 2256 of FIG. 35. The retrieving-processing function 1420 makes an inquiry to the campaign processing system 4200 about campaign information that is valid for a store corresponding to the store code 437 of the shopping information 430B, thereby acquiring discount information associated with the content of the campaign information and campaign entry information for the user of this mobile phone 300 in block 2258. The retrieving-processing function 1420 checks the content of the campaign information for the user of this mobile phone 300 indicated by the additional information 765 and the validity of the content by using the inquiry result in block 2260. The retrieving-processing function 1420 edits the record of the shopping information 430B (discount processing) or adds a record (a coupon record) in block 2262 if necessary.

At the same time, the campaign management system 4200 specifies the user of the mobile phone who submitted entry for the campaign and specifies the campaign using the shopping information 430B acquired from the campaign information system 2200, with reference to the campaign management database 4210, and registers an entry state to the campaign management database 4210. A campaign creation-evaluation system 4220 operates the campaign management database 4210, thereby measuring effects of past campaigns, and creating and registering new campaigns. Here, the campaign management system 4200 indicates, for example, a system such as UNICA and COREMETRICS from IBM.

The shopping-payment management system 500 acquires the edited shopping information 430B from the additional information service processing system (such as the item variation management system 2000 or the campaign information system 2200), and performs a payment process. The shopping-payment management system 500 then sends the payment information 580 to the store system 700, and completes a shopping process.

Next, regarding the block in which the mobile phone 300 displays the acquired item information 760 containing the additional information 765 on the screen and creates the shopping information 430B, examples of the screen of the mobile phone 300 will be described in detail. FIG. 36 illustrates examples of the screen on which the mobile phone 300 displays the item information 760 acquired from the item tag 100.

From the item tag 100 for an item “gray straight pants”, the mobile phone 300 acquires item information 760 containing “G clothing” as the manufacturer 761, “straight pants color: gray size: waist 82 inseam 78” as the item name 762, “4908420099023” as the item code 763, “1980 yen” as the price 764, and “A550” as the store code 766. When the additional information service is added, the mobile phone 300 further acquires additional information of an identifier “C03” as a color table, an identifier “S02” as a size table, and identifiers “M002” and “D003” as campaigns. When the additional information service is added, the item information 760 containing the item name 762 “straight pants color: %% C03%{gray} size: %% S02%{82 78} %% M002%{%} %% D003%{%}”, for example, is acquired.

In order to explicitly indicate that information is added at the item name part of the display screen of the mobile phone 300, part where the information is to be added is sandwiched by special character strings “%{” and “%}”, immediately in front of which the identifier preceded by a special character string “%%” is inserted in this example. Specifically, it is indicated that there are options of different colors represented by the color table C03 for “gray” and options of different sizes represented by the size table S02 for “waist 82 inseam 78”. It is also indicated that this item is a target item of the campaign codes M002 and D003.

The mobile phone 300 extracts the additional information 765 from the acquired item information 760. In the above example, the identifier is encoded in the additional information in a manner such that “%%”, the identifier, “% {”, “information to be added”, “%}”. Accordingly, by detecting “%%” from the acquired item information, the mobile phone 300 can acquire the identifiers (C03, S02, M002, and D003) of the additional information 765 and positions where additional information is to be displayed. Subsequently, the mobile phone 300 acquires the content of the acquired additional information 765 with reference to the additional information database 340 of the mobile phone 300.

FIG. 22 illustrates an example of the additional information database 340. The additional information database 340 is provided in the mobile phone 300, and is used by the mobile phone 300 to acquire content of the acquired additional information 765. Each record stored in the additional information database 340 contains information about the valid store list 341, the identifier 342, the content 343, the expiration date 344, and the state 345.

The valid store list 341 indicates stores for which the content 343 of the record of the line is valid. The valid store list 341 may specify only one specific store (only F203 or A550), a plurality of stores (A550 and A551), or all chain stores (stores of an A group, i.e., from A001 to A999). The identifier 342 indicates the identifier for which the content 343 of the record of the line is valid. The content 343 indicates content that is substituted for the identifier contained in the acquired item information 760. The illustrated example shows a simple expression but the content 343 may include a script or program.

The expiration date 344 indicates the date on which the content 343 of the record of the line expires. The mobile phone 300 deletes expired content from the additional information database 340 at an appropriate timing (such as when the application is started). The state 345 indicates the usage state of the content 343 of the record of the line. The state 345 stores the type of operation, such as displayed, entry submitted, or cancelled, performed for the content 343 in the mobile phone 300 in the past.

Displayed content can be corrected if necessary using this information about the state 345. For example, the mobile phone 300 can notify a customer of the “displayed” or “entry submitted” content by changing the display color depending on the past operation state when displaying the item information 760 (e.g., campaigns 2232 and 2234 in screens B to D of FIG. 36) on the screen of the mobile phone 300.

This can inform the customer that the current information is the same information as that was displayed before or the information for which the customer has already submitted entry, and thus can improve the usability. For example, when entry has been already submitted (including automatic entry), the entry button (such as an entry button 2226 of screens F to G of FIG. 36) may be removed from detailed screens, and “entry submitted” or the like may be displayed on the detailed screens.

Furthermore, when the number of times the customer can submit entry increases as the number of times of acquisition of shopping information increases, information, such as a count satisfying the condition or the last entry date and time, may be recorded in the state 345, whereby corresponding information can be displayed in the item information display screen or detailed screen. In order to acquire content corresponding to the acquired additional information 765, records having the identifier 342 field that matches the identifier of the additional information 765 are extracted. Then, a record having the store code 766 that matches the acquired store code 766 is further extracted. The content 343 of the extracted record corresponds to the additional information 765.

For example, in the above example, since the color table with the identifier C03 is acquired at the store A550, only one record having “(stores of a chain) A” as the valid store list 341 and “C03” as the identifier 342 satisfies the condition. Also, since the expiration date 344 is “Dec. 31, 2020”, today is before the expiration date, and “select color, {gray, black, oak}” is determined as the content 343.

On the other hand, when the color table with the same identifier C03 is acquired at another store A551, the color table additionally includes a limited color “gold” for a limited period (until Dec. 31, 2011) at limited stores (only at A551 and A552) though these stores belong to the same group A. There are two pieces of content 343 satisfying the condition (“select color”, {gray, black, oak}” and “select color”, {gray, black, oak, gold}) for the store A551. When a plurality of candidates are found, there is a predetermined rule for narrowing down the candidates to one, such as the priority is given to a candidate with a more limited valid store list 431 or expiration date 344, a candidate with a smaller number of bytes of the content 343, or a candidate with a smaller hash value of the content 343.

Conversely, there may be no record that satisfies the condition as a result of narrowing down and extracting records using the identifier 342, the valid store list 341, and the expiration date 344. In such a case, if the mobile phone 300 updates the additional information database 340 to acquire the latest additional information, the mobile phone 300 may acquire the content. In addition, the content 343 for a campaign S223 acquired at the store A550 is “NULL”. This indicates that this campaign S223 does not target this mobile phone 300 and there is no additional information for this mobile phone 300.

Herein, the additional information includes the item variation information and the campaign information. Examples of the item variation information of the additional information include a color table for clothing or the like. The examples of the additional information also include a size table for clothing or the like, a selection list of flavors or toppings for ice cream, and a selection list of side dishes for steak, such as vegetables, rice, and potato. Examples of the campaign information of the additional information include a year-round campaign, a monthly campaign, a daily campaign, and a time-limited special offer.

Classifying identifiers in accordance with the types of the additional information allows the mobile phone 300 to sort the content associated with the identifiers into display fields for the types of the additional information, or determine whether to acquire the latest information relative to the last update in accordance with a period of the campaign. For example, identifiers may be classified, for example, by starting identifiers for color tables with C and starting identifiers for size tables with S. Also, campaigns may be distinguished from one another, for example, by starting identifiers for a year-round campaign, a monthly campaign, a daily campaign, a time-limited special offer with Y, M, D, and S in accordance with periods of the campaigns, respectively.

Referring again to FIG. 36, screens A to G show the acquired item information 760 displayed by the mobile phone 300. The screen A of FIG. 36 is a diagram showing basic information of the item information 760 acquired by the mobile phone 300. When no additional information service is added, this screen serves as the basic screen. Even when there is an additional information service but identifiers (e.g., C03, S02, M002, and D003) of additional information are invalid, the screen A is displayed.

Here, invalid identifiers of additional information indicate that the identifiers are not for this mobile phone 300, the expiration date has come, or the additional information has not been acquired. The screen A shows a screen title “shopping confirmation screen” at line 2020, the item name 762 at lines 2022, 2024, and 2026, and the price 764 “¥1990” at line 2028. The screen A also shows a personalized price at line 2030, and a discount between the price 764 and the personalized price at line 2032. The personalized price is a discounted price calculated by the mobile phone 300 in accordance with a coupon or the like issued by the mobile shopping system. Line 2034 shows a drop-down menu allowing a customer to specify the quantity that they wish to buy. Furthermore, a buy button 2036 and a next-item button 2040 are provided at the bottom part of the screen. If the buy button 2036 is pushed, the item is registered to the shopping information 430A as a to-be-purchased item. If the next-item button 2040 is pushed, the item is registered to the shopping information 430A as a not-to-be-purchased item.

Moreover, when the bookmark system 1800 is added, a BM button 2038 is also shown. If the BM button 2038 is pushed, the item is registered to the shopping information 430A as a bookmarked item. After finishing the operation for one shopping target item by pushing the buy button 2036, the BM button 2038, or the next-item button 2040, the customer acquires item information of the next shopping target item or performs an operation for a payment process of the acquired shopping information 430A to complete shopping.

The screen C of FIG. 36 shows a state in which the additional information service is added, the same item information 760 as that in the example of the screen A above is acquired, and the pieces of additional information C03, S02, M002, and D003 contained in the item name 762 “straight pants color: %% C03%{gray} size: %% S02%{82 78} %% M002%{%] %% D003%{%}” are applied. Comparison of the screen C with the screen A indicates that line 2024 for color and line 2026 for size are changed to drop-down menus because of the additional information C03 and CO2, so that the color and size can be changed into another color and another size, respectively.

Moreover, the comparison of the screen C with the screen A indicates that two campaigns are displayed at the bottom part of the screen. The additional information M002 corresponds to a “multiple purchase campaign” 2232, whereas the additional information D003 corresponds to a “belt campaign” 2234. A menu 2042 is displayed upon the color drop-down menu 2024 being clicked in the screen C. Although the shopping target item is gray in color, it can be changed into the same item of another color. In this case, content enables the specified color to be changed using a single selection menu.

If the content description language is expanded by using, for example, HTML (Hyper Text Markup Language), options and selections may be specified in various ways, such as single selection, selection of zero or more options, selection of one or more options, and selection of three options. Likewise, a menu 2044 is displayed upon the size drop-down menu 2026 being clicked. The menu 2044 allows a customer to specify and buy the shopping target item of a different size. In addition, upon the campaigns 2232 and 2234 being clicked in the screen C, the screens F and G are displayed as detailed campaign screens, respectively. The screens F and G contain a cancel button 2228, which allows the customer to check the content of the screens and return the screens to the screen C.

Some campaigns do not automatically set customers as entry targets but require them to click to submit entry for the campaigns. With this configuration, it is possible for retailers to clearly show benefits to participate in the campaign to customers and to save unnecessary cost needed for customers who buy the item regardless of the campaigns. In a case of the campaign requiring entry, an entry button 2226 for confirming entry is provided in the screens F and G.

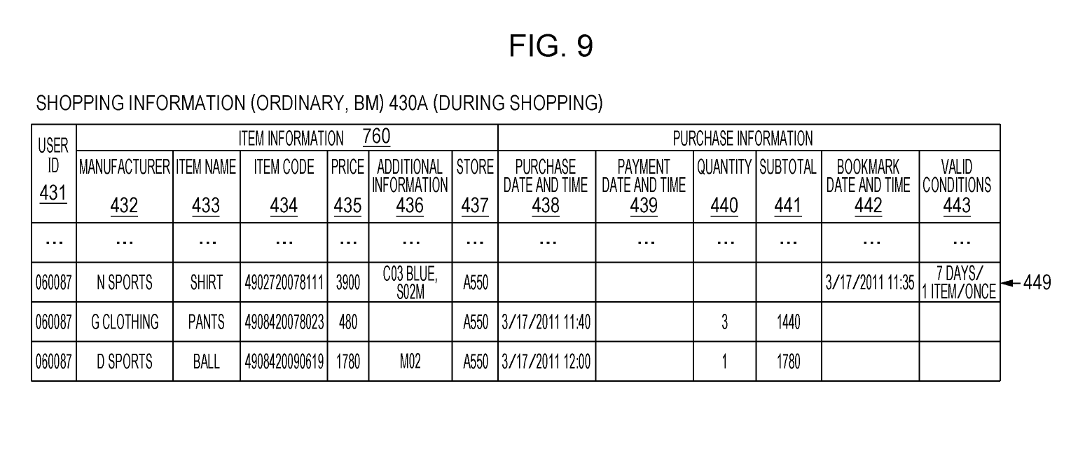

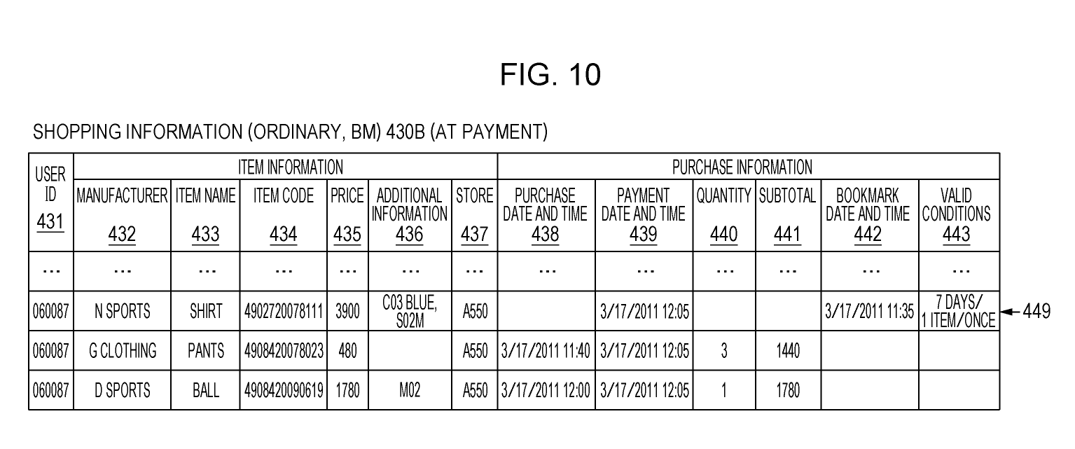

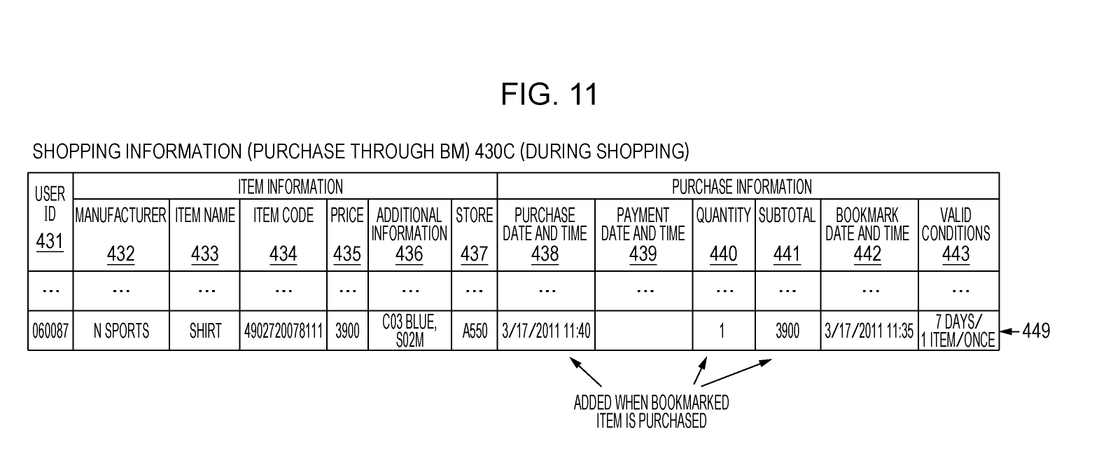

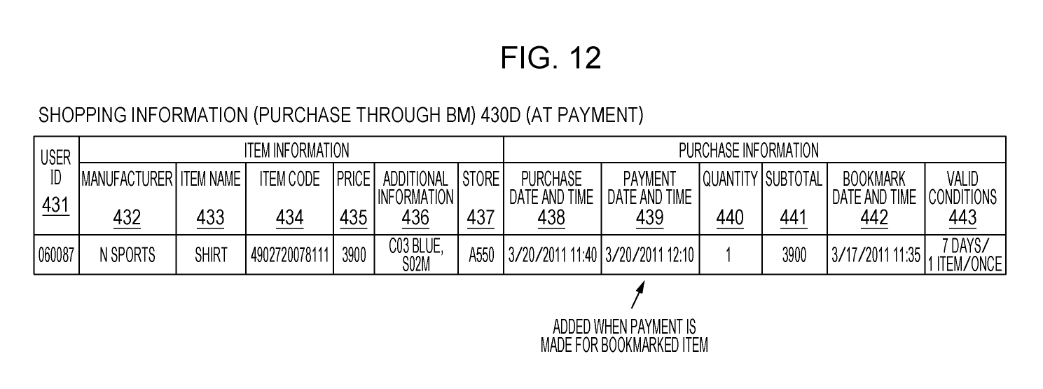

Selection and display operations performed on the screens A to G of the mobile phone 300 are recorded in the additional information 436 of the shopping information 430A along with the operation date and time and the operation results. For example, a list of sets of additional information having been operated and the operation result thereof is recorded in the additional information 436 of FIG. 9. For example, “C03 blue” indicates that blue is selected with reference to the color table C03. “S02 M” indicates that M is selected with reference to the size table S02. Although only the additional information and the operation result are written in FIG. 9 for simplification, a detailed list may be written by describing the operation process along with timestamp.

In such a way, the information about the shopping target item is recorded in detail. For example, at 10:28:30 AM on Nov. 5, 2011, the color table C03 is displayed. At 10:28:35 AM, the color is changed by selecting pink. Furthermore, at 10:28:50 AM, the color table C03 is displayed. At 10:29:5 AM, the color is changed by selecting blue. At 10:29:45 AM, the campaign Y0002 is clicked and the detail thereof is displayed. At 10:30:40 AM, the entry button is pushed to submit entry for the campaign.

Additional information that has not been operated may be recorded in the additional information 436 of the shopping information 430A without parameters (operation record and operation time). With this configuration, effects of additional information may be measured. Also, additional information that is still valid and was displayed with “entry submitted”, such as a campaign that the customer has already submitted entry, should be contained in this shopping information as “displayed as entry submitted” even though no entry operation is performed during this shopping.

This enables analysis of the frequently selected colors, effects of the campaign, and so forth in accordance with whether or not the campaign is additionally displayed and the time required from displaying to selection. Referring again to FIG. 36, the description will continue.

In order to display the acquired additional information on the screen, the mobile phone 300 acquires the corresponding content with reference to the additional information database 340. For example, the color table assigned the identifier C03 has content “select color, {gray, black, oak}”. The mobile phone 300 replaces part of the screen A displaying “gray” with a selection menu for gray, black, and oak, and then sets the default value to “gray”, which is the color of the shopping target item.

In addition, regarding campaigns, the mobile phone 300 displays only titles thereof at the margin, and determines whether the customer submits entry on the detailed screen through clicking. By including the campaign type in the description of the content, not only an entry-type campaign but also various types of campaigns, such as an automatic entry type, can be specified.

Similar to the screen C, the screens B and D of FIG. 36 illustrate a state in which the additional information service is added, the same item information 760 as that in the example of the screen A above is acquired, and the pieces of additional information C03, S02, M002, and D003 contained in the item name 762 “straight pants color: %% C03%{gray} size: %% S02%{82 78} %% M002%{%} %% D003%{%}” are expanded.

In screen D, the campaign 2234 is displayed but the campaign 2232 is not. That is, a campaign of the acquired pieces of additional information is not displayed. This is because the mobile phone 300 displaying the screen D acquires content NULL (non-target) when making an inquiry about the additional information M002 to the additional information database 340.

The screen B appears to be the same as the screen C at a glance but the detailed screen displayed in response to clicking the campaign 2232 is the screen E, which is different from the screen F. This is because the mobile phone 300 displaying the screen B and the mobile phone 300 displaying the screen C have different contents when making an inquiry about the additional information M002 to the respective additional information databases 340 of the mobile phones 300. Thus, pieces of offer information to be displayed also differ.

Subsequently, a method for updating and managing the additional information database 340 of the mobile phone 300 will be described. The additional information database 340 is desirably managed to be the latest state so that the mobile phone 300 can correctly interpret the additional information 765 acquired from the item information 760. If the acquired additional information 765 is not found in the additional information database 340 or has expired, the mobile phone 300 is unable to display the acquired additional information 765 unless the additional information database 340 is updated (only corresponding additional information is acquired or the entire additional information database is updated). In such a case, the mobile phone 300 does not display the additional information or displays information including the additional information after acquiring the additional information.

Since updating the additional information database 340 may involve at least one of the customer's operation, communication cost, and suspension or delay of the shopping operation of the customer, the mobile phone 300 may make an inquiry about whether to perform update to the customer before updating. Only when customer's agreement is obtained, updating may be performed. When the mobile phone 300 does not display the additional information, the mobile phone 300 may notify a customer that new additional information will be possibly displayed if the additional information database 340 is updated. The mobile phone 300 makes this notification by displaying a screen, or using sound or vibration.

In a case of displaying the additional information after partially and entirely updating the additional information database 340, the mobile phone 300 may notify the customer of an operation of updating by displaying a screen or using sound or vibration. Here, an updating method includes the following: the customer finding an additional information tag, and the mobile phone 300 acquiring additional information from the additional information tag placed thereover by the customer.

For example, if the additional information database 340 does not contain the additional information 765 regarding item color-size variations contained in the item information 760 acquired from the item tag 100 for a sweater (color: blue, size: M) at a clothing store, the mobile phone 300 reads an additional information tag for color and size code tables that is provided at the entrance or on the wall or pillar of the clothing store, thereby updating the additional information database 340.

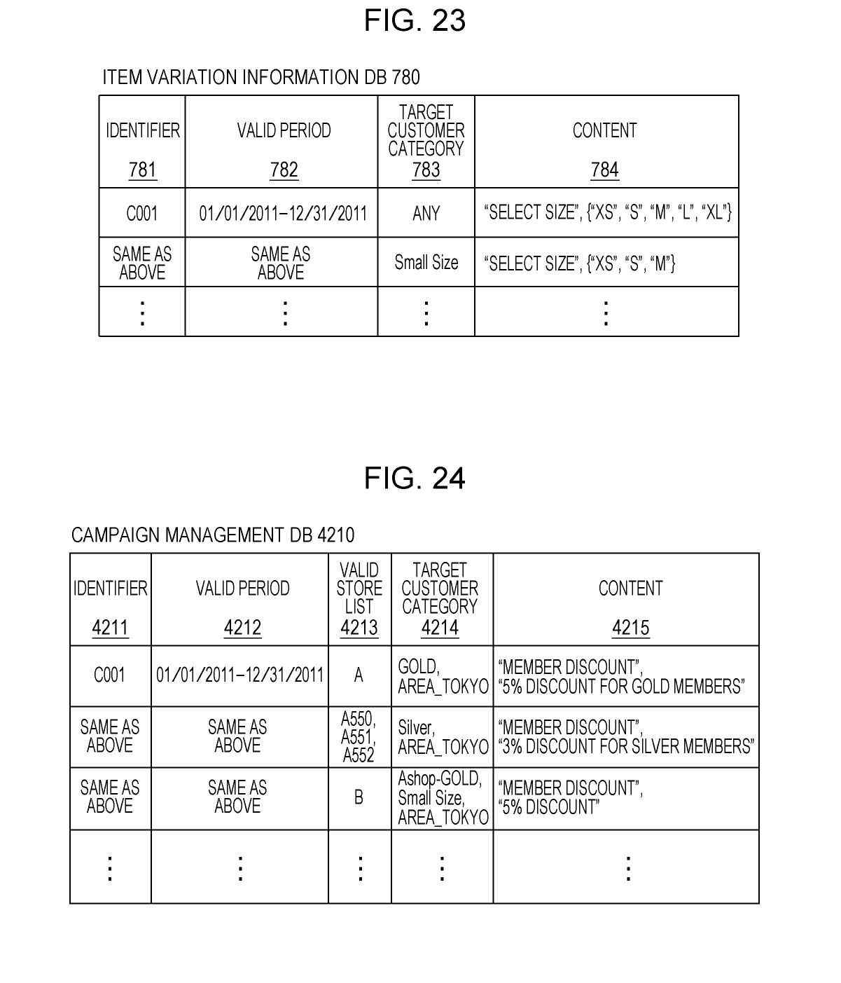

In this case, the additional information tag acquires additional information handled by this clothing store from the item variation information management database 780 illustrated in FIG. 23, and provides an identifier 781, a valid period 782, and content 784 without limiting target customers 783. The mobile phone 300 acquires the entirety or necessary part of provided additional information. The necessary part indicates the additional information 765 contained in the item information 760 that is to be displayed now. If this part is acquired, the mobile phone 300 need not acquire the entire additional information at a time. Additional information is not made available in this shopping, when the additional information is acquired for specific customers after the shopping is finished or while the additional information database is being updated.

The additional information tag may also acquire the additional information handled by this clothing store from the item variation information management database 780 illustrated in FIG. 23, and provide the identifier 781, the valid period 782, the target customers 783, and the content 784, including information for the limited target customers 783. When acquiring the provided additional information, the mobile phone 300 compares the provided additional information with registration information and customization information related to the mobile shopping system and stored in the mobile phone 300 (such as basic information and preference information related to the user of the mobile phone 300 or the customer who shops using the mobile shopping system) to search for matching information, thereby acquiring the entirety or necessary part of information for the mobile phone 300.

In another updating method, the mobile phone 300 automatically or if necessary prompts a customer to perform an operation for agreement, communicates with the additional information service processing system (the item variation management system 2000 or the campaign information system 2200) typically via the Internet 10 using a communication function, such as a mobile phone network or a wireless LAN, to acquire update information of the additional information database 340, thereby acquiring the entirety or necessary part of additional information for the mobile phone 300.

Here, the necessary part is acquired in the following manner. During communication, the mobile phone 300 sends an inquiry containing the desired additional information, the ID of the customer using the mobile phone 300, and the ID of the store where the item information has been acquired as parameters thereof, to the additional information service processing system (the item variation management system 2000 or the campaign information system 2200). Alternatively, the necessary part is acquired in the following manner. During communication, the extended shopping management system 1400 extracts the update information of the additional information database 340 of the target mobile phone 300 from the shopping information database 1430, and sends the differential of additional information from the last update.

By using the same mechanism as the aforementioned mechanism used at the time of payment, the additional information service processing system, i.e., the item variation management system 2000 or the campaign information management system 2200, acquires the additional information 765 for the mobile phone 300 from the item variation database 760 or the campaign management database 4210. In still another updating method, when displaying the payment result (block 370 of FIG. 26) after receiving payment result information from the shopping-payment management system 500, the mobile phone 300 updates the additional information database 340 to the latest state by using update information acquired from the additional information service processing system (the item variation management system 2000 or the campaign information system 2200) via the shopping-payment management system 500 with the same method as the aforementioned one. In still another updating method, the mobile phone 300 updates the additional information database 340 to the latest state, in response to a customer's permission, automatically, or regularly, before shopping is started.

More specifically, if a mode for maintaining the additional information database 340 other than ordinary shopping is selected in block 354 of FIG. 26, the mobile phone 300 first acquires the last update date and time of the additional information database 340 in block 384, and determines the necessity for updating the additional information database 340 in block 386. If updating is needed while avoiding excessive update procedures, the mobile phone 300 communicates with the additional information service processing system (the item variation management system 2000 or the campaign information system 2200) to acquire differential information necessary for updating in block 388. In block 390, the mobile phone 300 deletes expired additional information from the additional information database 340, and then adds the acquired additional information, thereby updating the additional information database 340 to the latest state, and also updates the last update information.

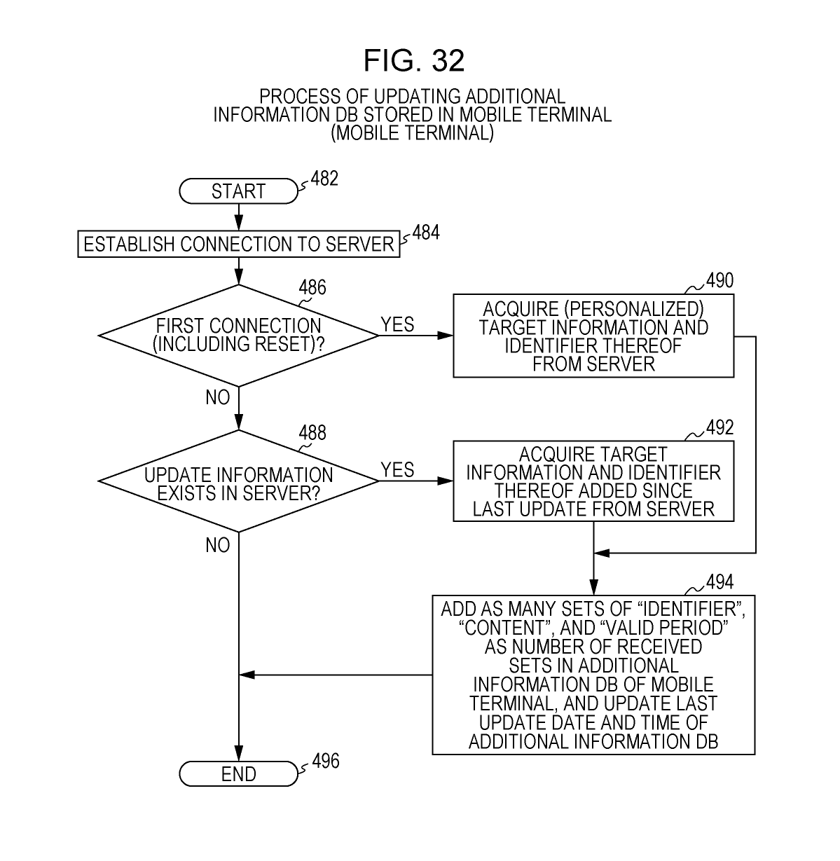

If it is determined that the update is unnecessary in block 386, the mobile phone 300 re-organizes the additional information database 340, such as deleting expired additional information, in block 390. FIG. 32 illustrates an example 480 of the flow in which the mobile phone 300 performs maintenance of (including newly introducing) the additional information database 340. In block 484, the mobile phone 300 first establishes a connection to the additional information service processing system (the item variation management system 2000 or the campaign information system 2200). In block 486, whether this connection is the first connection from the mobile phone 300 or connection for updating is determined. Here, the first connection includes resetting.

In a case of connection for updating, the mobile phone 300 checks whether or not the additional information service processing system (the item variation management system 200 or the campaign information system 2200) has update information in block 488. If no update information is found, the mobile phone 300 disconnects communication and terminates the process. If the update information is found, the mobile phone 300 acquires update information having been added since the last update from the additional information service processing system in block 492.

In block 494, the additional information service processing system sends update information customized for the customer associated with the user ID of the mobile phone 300. The mobile phone 300 receives the update information, and updates the additional information database 340 thereof. The update information contains the identifier 341, the content 343, the state 345, and the expiration date 344. The mobile phone 300 further updates the update date and time information of the additional information database 340. Then the mobile phone 300 disconnects communication and terminates the process. In a case of the first connection in block 486, the mobile phone 300 acquires (personalized) target information and the identifier thereof from the additional information service processing system in block 490. The process then proceeds to block 494.

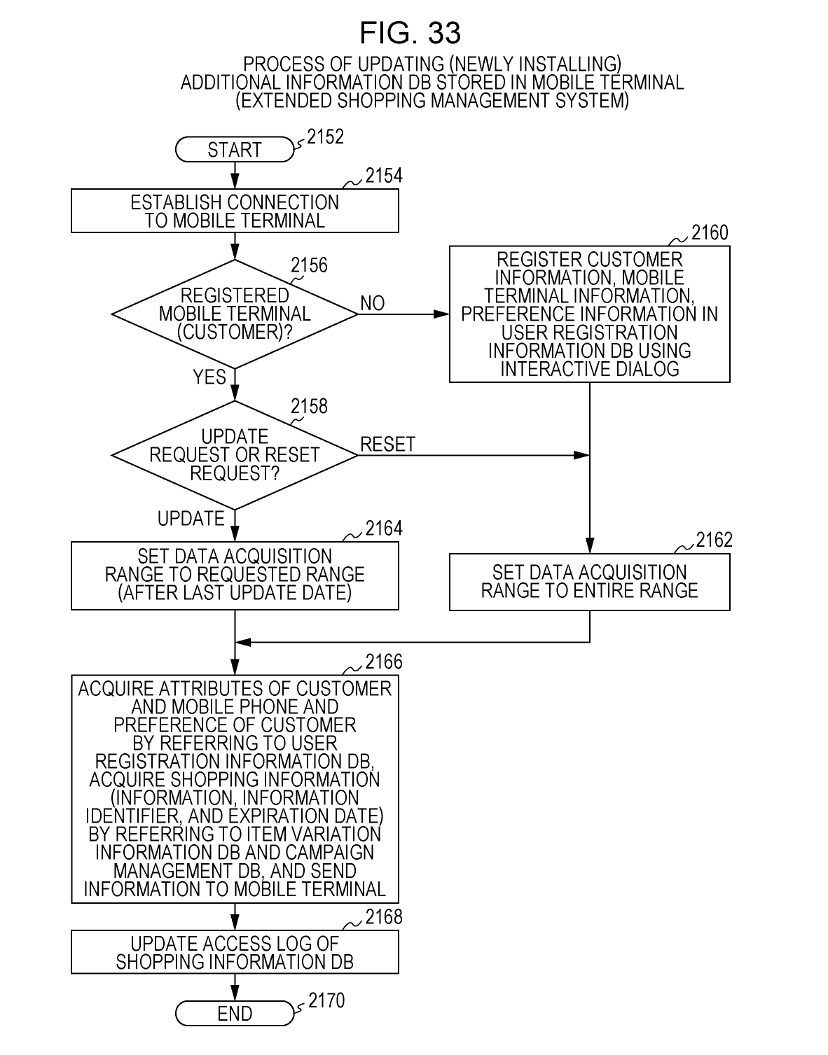

FIG. 33 illustrates an example 2150 of the flow in which the additional information service processing system (the item variation management system 2000 or the campaign information system 2200) communicates with the mobile phone 300 for maintenance of the additional information database 340. In block 2154, the additional information service processing system establishes a connection to the mobile phone 300 and starts communication. In block 2156, the additional information service processing system determines whether the mobile phone 300 has been registered to the user registration information database 900. In a case of the unregistered mobile phone 300 in block 2156, the additional information service processing system acquires customer information, mobile terminal information, and preference information from the mobile phone 300, and updates the user registration information database 900 in block 2160. For example, an interactive dialog box or the like may be presented on the screen of the mobile phone 300 to allow a customer, i.e., the user of the mobile phone 300, to input the information. In a case of the registered mobile phone 300 in block 2156, the additional information service processing system determines which of resetting or updating is requested in block 2158.

If resetting is requested in block 2158, or after executing block 2160, the additional information service processing system sets the entire additional information database 340 as the range to be updated in block 2162. The process proceeds to block 2166. If updating is requested in block 2158, the additional information service processing system sets the range to be updated in the additional information database 340 to the differential update from the last update date in block 2164. The process then proceeds to block 2166. The last update date is recorded in the shopping information database 1430. The additional information service processing system acquires the update record of the additional information database 340 of the target mobile phone 300, and uses the acquired one.

In block 2166, the additional information service processing system acquires target customer category information that satisfies the attribute of the mobile phone 300 and the basic and preference information of the customer, i.e., the user of the mobile phone 300, with reference to the user registration information database 900; acquires additional information that is valid for the target customer category and whose validity has not expired from the item variation information database 780 and the campaign information database 4210; and sends the additional information to the mobile terminal 300. Lastly in block 2168, the additional information service processing system adds a record of updating the additional information database 340 to the shopping information database 1430.

In block 2050 or 2250 of the flowchart of the shopping-payment management system 500 of FIG. 27, the item variation process 2050 (FIG. 34) and the campaign process (FIG. 35) are called, respectively. FIG. 34 illustrates an example 2050 of the flow in which the retrieving-processing function 1420 acquires additional information from the shopping information 430B and corrects the shopping information 430B when the additional information service processing system is the item variation management system 2000.

In block 2054, the retrieving-processing function 1420 acquires the additional information along with the store information and the item code from the shopping information 240B, thereby acquiring the identifier and the parameters (such as the specified parameter and the operation date and time) to be processed by the item variation management system 2000. Subsequently, in block 2056, the retrieving-processing function 1420 stores the acquired additional information (the identifier and the parameters) in the shopping information database 1430. Subsequently, in block 2058, the retrieving-processing function 1420 refers to the item variation information database 780 of the corresponding store, and corrects the shopping information 430B if necessary using the acquired additional information (the identifier and the parameters) by changing the item code to the item code for the specified variation.

FIG. 35 illustrates an example 2250 of the flow in which the retrieving-processing function 1420 acquires additional information from the shopping information 430B and corrects the shopping information 430B when the additional information service processing system is the campaign information system 2200. In block 2254, the retrieving-processing function 1420 acquires the additional information along with the store information and the item code from the shopping information 430B, thereby acquiring the identifier and the parameters (such as the specified parameter and the operation date and time) to be processed by the campaign information system 2200.

Subsequently, in block 2256, the retrieving-processing function 1420 records the acquired additional information (the identifier and the parameters) in the shopping information database 1430 and the campaign management database 4210, as shopping information and campaign effect information, respectively. Here, the parameters indicate an operation state of each campaign (displayed and entry submitted, only displayed, not displayed) and the time of the operation. From these parameters, how much each campaign interests the customer can be analyzed.

In block 2258, the retrieving-processing function 1420 extracts the campaign identifiers (including those without operation records) contained in the additional information of the shopping information 430B, and further extracts the campaign identifiers valid for this shopping, such as “entry submitted” and “automatic entry”, from the shopping information database 1430.

In block 2260, the retrieving-processing function 1420 compares a campaign corresponding to the campaign identifier extracted in block 2258 with the shopping information 430B, and generates information on the applicable campaign whose conditions are met and a reward that can be provided by applying the campaign (such as a discount coupon for this shopping). In block 2262, the retrieving-processing function 1420 corrects the shopping information 430B by applying the campaign thereto, such as by adding the reward (discount coupon) determined in block 2260 to the shopping information 430B.

FIG. 23 illustrates an example of the configuration of the item variation information database 780. The item variation information database 780 is included in the store system 700 at each store, and stores the identifier 781, the valid period 782, the target customer category 783, and the content 784 of additional information provided by the store. The identifier 781 is coded information contained in an item tag as additional information.

The valid period 782 indicates a valid period of the identifier 781 of each additional information record equivalent to one line of the item variation information database 780. In a store having installed a purchase-through-bookmark service, an expired table also needs to be stored. The target customer category 783 indicates categories of users or mobile phones 300 for which variations of each record are valid. For example, “ANY” indicates that all mobile phones 300 are targeted. In addition, “Small Size” indicates that only mobile phone 300 that users who purchase only small size items have registered in the item variation management system 2000 are targeted.

The content 784 indicates the meaning of the identifier 781 of the corresponding record. FIG. 24 illustrates an example of the configuration of the campaign management database 4210. The campaign management database 4210 is maintained by the campaign management system 4200, and stores the identifier 4211, the valid period 4212, the target store list 4213, the target customer category 4214, and the content 4215 of a campaign that is managed by the campaign management system 4200. The identifier 4211 is coded information contained in an item tag as additional information.

The valid period 4212 indicates a valid period of the identifier 4211 of each additional information record equivalent to one line of the campaign information database 4210. In a store having installed a purchase-through-bookmark service, an expired table also needs to be stored. The target store list 4213 is a list of stores or group stores targeted by a campaign of each record. Here, the group stores include stores of the same or similar business types of a chain (such as branch stores of a single supermarket chain) and alliance stores of different business types or managements (such as alliance stores that handle rewards cards of one type).

The target customer category 4214 indicates categories of users or mobile phones 300 for which a campaign of each record is valid. For example, “GOLD” indicates that users of the mobile phones 300 are GOLD members. In addition, “Ashop-GOLD” indicates GOLD members at stores of an A group. Giving preferential treatment to “Ashop-GOLD” at stores of a B group indicates an example in which stores of B group preferentially treat premium customers at stores of the A group at a tie-up event with the A-group stores. The content 4215 indicates the meaning of the identifier 781 of the corresponding record.

While the disclosure has been described with reference to an exemplary embodiment or embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A point of sale interface (POS IF) emulator system, comprising:
a payment data processing-verification device that processes payment information in accordance with POS device information, emulates a POS input operation, and inputs the processed payment information to a POS device through a keyboard interface;
the payment information being created from payment information extracted from shopping information and payment information acquired from user registration information, the shopping information being created by a mobile phone by acquiring item information from an item tag for an item and by performing the acquisition one or more times;
wherein payment is made at the POS device corresponding to the POS device information.

2. The POS IF emulator system according to claim 1, wherein the payment data processing-verification device further acquires, in accordance with the POS device information, an output displayed by the POS in response to the inputting.

3. The POS IF emulator system according to claim 2, wherein the payment data processing-verification device compares the output displayed by the POS device with the payment information input to the POS device, and whenever the output is different from the input payment information, the payment data processing-verification device emulates a POS operation and inputs a canceling operation to the POS device through the keyboard interface.

4. The POS IF emulator system according to claim 2, wherein:
the payment data processing-verification device compares the output displayed by the POS device with the payment information input to the POS; and
whenever the output is different from the input payment information and the payment information input to the POS device indicates a lower price than the output, the payment data processing-verification device inputs a canceling operation to the POS device.

5. The POS IF emulator system according to claim 2, wherein:
the payment data processing-verification device compares the verified output from the POS device with the payment information input to the POS device; and
whenever the output is different from the input payment information, the payment data processing-verification device notifies a store system including the POS device of the mismatch.

6. The POS IF emulator system according to claim 1, wherein payment information for each store is extracted by using store information contained in the shopping information so that payment can be made at a POS device in the store.

7. A mobile shopping system, comprising:
a point of sale interface (POS IF) emulator system including a payment data processing-verification device that processes payment information in accordance with POS device information, emulates a POS input operation, and inputs the processed payment information to a POS device through a keyboard interface, the payment information being created from payment information extracted from shopping information and payment information acquired from user registration information, the shopping information being created by a mobile phone by acquiring item information from an item tag for an item and by performing the acquisition one or more times, wherein payment is made at the POS device corresponding to the POS device information; and
a shopping-payment management system that extracts the payment information from the created shopping information and acquires the extracted payment information.

8. A mobile shopping system according to claim 7, further comprising a plurality of the POS IF emulator systems configured to extract payment information for each of a plurality of stores by using store information contained in the shopping information so that payment can be made at a corresponding POS device in each of the plurality of stores.

9-14. (canceled)

15. A computer readable storage medium having computer readable instructions stored thereon that, when executed by a computer, perform a method of implementing a point of sale interface (POS IF) emulator system, the method comprising:
processing, with a payment data processing-verification device, payment information in accordance with POS device information, emulating a POS input operation, and inputting the processed payment information to a POS device through a keyboard interface;
the payment information being created from payment information extracted from shopping information and payment information acquired from user registration information, the shopping information being created by a mobile phone by acquiring item information from an item tag for an item and by performing the acquisition one or more times;
wherein payment is made at the POS device corresponding to the POS device information.

16. The computer readable storage medium according to claim 15, wherein the method further comprises acquiring, with the payment data processing-verification device, in accordance with the POS device information, an output displayed by the POS in response to the inputting.

17. The computer readable storage medium according to claim 16, wherein the method further comprises comparing, with the payment data processing-verification device, the output displayed by the POS device with the payment information input to the POS device, and whenever the output is different from the input payment information, emulating a POS operation and inputting a canceling operation to the POS device through the keyboard interface.

18. The computer readable storage medium according to claim 16, wherein the method further comprises:
comparing, with the payment data processing-verification device, the output displayed by the POS device with the payment information input to the POS; and
whenever the output is different from the input payment information and the payment information input to the POS device indicates a lower price than the output, inputting a canceling operation to the POS device.

19. The computer readable storage medium according to claim 16, wherein the method further comprises:
comparing, with the payment data processing-verification device, the verified output from the POS device with the payment information input to the POS device; and
whenever the output is different from the input payment information, notifying a store system including the POS device of the mismatch.

20. The computer readable storage medium according to claim 15, wherein payment information for each store is extracted by using store information contained in the shopping information so that payment can be made at a POS device in the store.
